(19) United States
(12) Patent Application Publication
(10) Pub. No.: US 2026/0352713 A1
(43) Pub. Date: Nov. 5, 2026

(54) SECURITY AND COMPLIANCE IN CLOUD-BASED INFRASTRUCTURE

(71) Applicant: AutoRABIT Holding, Inc., San Francisco, CA (US)

(72) Inventors: Pablo Jose Gonzalez Alvarez, Castleknock (IE); Patricia Aleixo, Prague (CZ); Eric Pearson, Madison, CT (US); Branislav Kovácik, Plzen (CZ); Vladimir Ivannikov, Plzen (CZ)

(21) Appl. No.: 19/668,339

(22) Filed: May 5, 2026

Related U.S. Application Data
(60) Provisional application No. 63/800,221, filed on May 5, 2025.

(51) Int. Cl. H04L 9/40

(52) U.S. Cl. CPC H04L 63/20

(57) ABSTRACT

Examples relate to receiving candidate source files within a source code corpus associated with a tenant organization of a multi-tenant cloud platform triggers a process to identify security or quality issues. A deterministic parser generates structural skeletons for each source file, which are used in a first large language model invocation to output targeted-read requests. File ranges are read without language model invocation to produce source windows, and a second invocation outputs findings on security or quality issues. A categorical output is computed from numeric sub-scores, and a security enforcement action is performed based on the findings and output, such as blocking deployment or flagging a pull request, to ensure security and quality of the source code corpus.

### CROSS-REFERENCE TO RELATED APPLICATIONS

This Application claims priority to U.S. Provisional Patent Application No. 63/800,221, filed on May 5, 2025, entitled “SECURITY AND COMPLIANCE IN CLOUD-BASED INFRASTRUCTURE” the entire disclosure of which is incorporated herein by reference.

### TECHNICAL FIELD

The present disclosure relates to cloud-based infrastructure, and more specifically, to security and compliance in systems using cloud-based infrastructures.

### SUMMARY

Multi-tenant cloud platforms are increasingly adopted by enterprise organizations to manage complex operational environments spanning multiple tenant organizations, each with distinct configurations, user permission structures, and data assets. As the scale and complexity of these environments grow, so does the challenge of maintaining consistent security controls, enforcing governance policies, and demonstrating compliance with applicable regulatory frameworks. Security and compliance functions in multi-tenant cloud environments encompass a broad range of activities, including monitoring configuration changes, classifying sensitive data fields, analyzing user permission structures, assessing security posture against established baselines, and enforcing policy-based access controls across one or more connected tenant organizations.

Organizations managing multi-tenant cloud environments face significant challenges in securing those environments while maintaining compliance with evolving regulatory requirements. Conventional security tools lack cloud-platform-specific capabilities, creating vulnerabilities across key security domains. For example, conventional approaches provide limited visibility into real-time security threats and configuration vulnerabilities, and do not provide a structured security software development lifecycle for cloud platform implementations.

Conventional approaches also fail to address shadow configurations introduced without proper security oversight, and do not provide automated mechanisms for identifying and remediating excessive user permissions that may lead to inadvertent data exposure. With respect to governance, risk, and compliance, conventional approaches rely on complex manual processes for demonstrating regulatory compliance, and do not provide the ability to enforce consistent security policies across multiple tenant organizations or maintain comprehensive audit trails for security policy violations and permission changes. Furthermore, conventional security hygiene processes are time-consuming and manual in nature, resulting in inconsistent monitoring and remediation of security misconfigurations, difficulty identifying and revoking over-privileged user accounts, and the absence of automated systems for continuous security posture assessment.

Conventional approaches to automated source code analysis using language models present several specific technical challenges. First, prior approaches that feed entire source code repositories directly into a language model context experience token consumption that grows linearly with repository size, causing inference to fail entirely when the context limit is exceeded, producing degraded output quality as attention degrades over very long contexts, and resulting in unpredictable inference costs. Second, prior approaches that apply language model inference to generate a final categorical security verdict introduce nondeterminism into security enforcement decisions, because a nondeterministic model output cannot be reproduced exactly from the same input, making it virtually impossible to audit or replay a prior security determination. Third, unconstrained agentic systems in which the language model can invoke arbitrary tools present security risks in code analysis contexts, because a compromised or hallucinating model could modify source files or execute arbitrary code on the analysis infrastructure. Fourth, prior approaches to LLM-based data field classification that apply inference to every field in a cloud platform tenant organization result in inference costs that scale linearly with the total number of fields, regardless of sensitivity, and are subject to hallucinated classification categories that must be manually filtered. Fifth, prior approaches to cloud platform API batching that use static batch sizes result in systematic request-size-limit failures when the platform imposes limits that vary across tenant organizations or over time, wasting the computational work performed to assemble oversized batches.

As the foregoing illustrates, there is a need for computational systems and methods that provide automated, platform-specific security posture management, policy enforcement, data classification, and compliance monitoring across multi-tenant cloud environments. One example provides a process including: receiving a plurality of candidate source files within a source code corpus associated with a tenant organization of a multi-tenant cloud platform; generating, using a deterministic parser, a structural skeleton for each of the plurality of candidate source files; performing a first invocation of a large language model to output a plurality of targeted-read requests each specifying a location within a candidate source file, the first invocation including the structural skeletons and having a context bounded by a function of a size of the structural skeletons and a size of targeted source-content portions retrieved from the plurality of candidate source files; reading, without invocation of the large language model, file ranges identified by the targeted-read requests to produce a plurality of source windows; performing a second invocation of the large language model to output a set of findings identifying one or more security or quality issues, the second invocation including the structural skeletons and the plurality of source windows, wherein a context of the second invocation is bounded by the sum of the size of the structural skeletons and the size of the source windows and is independent of a number of targeted-read requests; computing a categorical output by applying a pure step function to a sum of a plurality of numeric sub-scores received from at least one of the first or second invocation; and based at least on the set of findings and the categorical output, performing a security enforcement action with respect to the tenant organization of the multi-tenant cloud platform to block a deployment to the tenant organization of the multi-tenant cloud platform, flag a pull request associated with the source code corpus, generate a deviation finding identifying a security or quality issue within the plurality of candidate source files, transmit a structured alert to a security service API associated with the tenant organization, or a combination thereof.

In some aspects, the first invocation is further to emit no findings with respect to the one or more security or quality issues within the plurality of candidate source files.

In some aspects, conversation history from the first invocation is not carried into the second invocation.

In some aspects, the categorical output is bit-identical across applications of the pure step function with identical numeric input.

In some aspects, each structural skeleton includes at least class identifiers, member signatures, annotations, and line ranges, and omits member bodies of the corresponding candidate source file.

In some aspects, the first invocation and the second invocation each receive a language-specific scanner-contradiction catalogue enumerating known false-positive patterns of a static analyzer in natural language, and wherein the set of findings output by the second invocation omits scanner hints contradicted by the plurality of source windows under the scanner-contradiction catalogue.

In some aspects, the first invocation further includes a set of scanner hints produced by executing a deterministic static analyzer over the plurality of candidate source files, each scanner hint identifying a file, a line or range, and a rule key.

In some aspects, at least one of the first invocation or the second invocation includes invoking the large language model as an agent with a tool surface having a closed read-only set including at least a skeleton-retrieval tool returning a pre-computed structural skeleton, a line-range file-read tool accepting a file identifier, a starting line offset, and a line limit, a directory-listing tool, a filename-pattern tool, a content-pattern tool, or a combination thereof.

In some aspects, the a system prompt associated with the first invocation requires that the large language model does not emit a negative result for any candidate source file unless the large language model has previously received, through the skeleton-retrieval tool, the structural skeleton of that candidate source file.

In some aspects, the plurality of numeric sub-scores includes, for each identified member of a candidate source file, a set of dimension-specific sub-scores each bounded to a fixed integer interval, and wherein a subset of scoring dimensions whose output is deterministically computable by a static rule engine from the source of the identified member is excluded from the first invocation or the second invocation.

In some aspects, the process further includes: serializing the set of findings and the categorical output to a token-optimized textual notation having a character count smaller than a JavaScript Object Notation serialization of the set of findings and the categorical output; and invoking a second large language model stage with the serialized token-optimized textual notation as input, the second large language model stage operating in a model tier of higher per-token cost than a model tier used for the first invocation and the second invocation.

In some aspects, the process further includes: caching each computed structural skeleton, and upon a subsequent reference to a candidate source file already processed during a same analysis run, serving the cached structural skeleton without re-invoking the deterministic parser.

In some aspects, receiving the plurality of candidate source files includes: selecting, from a registry of framework descriptors, a descriptor whose filename predicate matches each candidate source file, each descriptor including at least an identity, a filename predicate, and/or a prompt builder, and wherein, responsive to two or more descriptors matching a single candidate source file, a source-content predicate of each matching descriptor is evaluated against the source of the candidate source file to select exactly one descriptor.

Another example provides a computing system including: a processor; and a non-transitory computer readable medium storing instructions executable to: receive a plurality of candidate source files within a source code corpus associated with a tenant organization of a multi-tenant cloud platform; generate a structural skeleton for each of the plurality of candidate source files; perform a first invocation of a large language model to output a plurality of targeted-read requests each specifying a location within a candidate source file, the first invocation having a context bounded by a function of a size of the structural skeletons and a size of targeted source-content portions retrieved from the plurality of candidate source files; read file ranges identified by the targeted-read requests to produce a plurality of source windows; perform a second invocation of the large language model to output a set of findings identifying one or more security or quality issues, wherein a context of the second invocation is bounded by the sum of the size of the structural skeletons and the size of the source windows and is independent of a number of targeted-read requests; compute a categorical output by applying a pure step function to a sum of a plurality of numeric sub-scores received from at least one of the first or second invocation; and perform a security enforcement action with respect to the tenant organization of the multi-tenant cloud platform based at least on the set of findings and the categorical output.

In some aspects, the first invocation is further to emit no findings with respect to the one or more security or quality issues within the plurality of candidate source files.

In some aspects, the techniques described herein relate to a computing system, wherein conversation history from the first invocation is not carried into the second invocation.

In some aspects, the first invocation further includes a set of scanner hints produced by executing a deterministic static analyzer over the plurality of candidate source files, each scanner hint identifying a file, a line or range, and a rule key, and wherein the first invocation and the second invocation each receive a language-specific scanner-contradiction catalogue enumerating known false-positive patterns of the deterministic static analyzer in natural language, and wherein the set of findings output by the second invocation omits scanner hints contradicted by the plurality of source windows under the scanner-contradiction catalogue.

In some aspects, at least one of the first invocation or the second invocation includes invoking the large language model as an agent with a tool surface having a closed read-only set including at least a skeleton-retrieval tool returning a pre-computed structural skeleton, a line-range file-read tool accepting a file identifier, a starting line offset, and a line limit, a directory-listing tool, a filename-pattern tool, a content-pattern tool, or a combination thereof.

In some aspects, the instructions are further executable to: serialize the set of findings and the categorical output to a token-optimized textual notation having a character count smaller than a JavaScript Object Notation serialization of the set of findings and the categorical output; and invoke a second large language model stage with the serialized token-optimized textual notation as input, the second large language model stage operating in a model tier of higher per-token cost than a model tier used for the first invocation and the second invocation.

Another example provides a non-transitory computer readable medium storing instructions executable to: receive a plurality of candidate source files within a source code corpus associated with a tenant organization of a multi-tenant cloud platform; generate a structural skeleton for each of the plurality of candidate source files; perform a first invocation of a large language model to output a plurality of targeted-read requests each specifying a location within a candidate source file, the first invocation having a context bounded by a function of a size of the structural skeletons and a size of targeted source-content portions retrieved from the plurality of candidate source files; read file ranges identified by the targeted-read requests to produce a plurality of source windows; perform a second invocation of the large language model to output a set of findings identifying one or more security or quality issues, wherein a context of the second invocation is bounded by the sum of the size of the structural skeletons and the size of the source windows and is independent of a number of targeted-read requests; compute a categorical output by applying a pure step function to a sum of a plurality of numeric sub-scores received from at least one of the first or second invocation; and perform a security enforcement action with respect to the tenant organization of the multi-tenant cloud platform based at least on the set of findings and the categorical output.

Other aspects will become apparent by consideration of the detailed description and accompanying drawings.

When compared to conventional approaches described herein in which security monitoring, policy enforcement, and compliance verification are performed manually or through tools that lack cloud-platform-specific capabilities, with the disclosed techniques, a cloud infrastructure security service can operate as an automated, platform-aware security and compliance layer that governs configuration changes, enforces access control policies, and classifies sensitive data in real time across one or more connected tenant organizations. In that regard, at least one technical advantage of the disclosed techniques relative to conventional approaches is that, with the disclosed techniques, security policies are automatically enforced across all connected tenant organizations through a centralized service, thereby reducing the risk of unauthorized configuration changes and excessive permission assignments that conventional manual processes cannot detect or remediate in a timely manner.

At least another technical advantage of the disclosed techniques relative to conventional approaches is that, with the disclosed techniques, sensitive data fields are automatically identified and classified using large language model inference constrained by tenant-scoped regulatory vocabularies, thereby reducing the risk of undetected sensitive data exposure and non-compliance with applicable regulatory frameworks. In that regard, because the disclosed techniques enable continuous, automated monitoring of configuration changes, permission structures, and data classifications across multi-tenant cloud environments, the risk of security incidents, compliance violations, and audit failures arising from manual or reactive security processes is reduced.

### BRIEF DESCRIPTION OF THE DRAWINGS

FIG. 1 illustrates one embodiment of a computing environment, according to the present disclosure.

FIG. 2 is a block diagram of a cloud infrastructure security service that supports automated security posture management, policy enforcement, data classification, and compliance monitoring for multi-tenant cloud infrastructure, according to the present teachings.

FIG. 3 is a flow diagram of a process for machine-enforced multi-tenant configuration compliance, according to the present teachings.

FIG. 4 is a flow diagram of a process for executing batched requests against a remote API subject to request-size limits, according to the present teachings.

FIG. 5 is a flow diagram of a process for data classification in multi-tenant cloud infrastructure, according to the present teachings.

FIG. 6 is a flow diagram of a process for source code analysis, according to the present teachings.

FIG. 7 is a flow diagram of a process for orchestration of LLM agents over source code repositories, according to the present teachings.

FIG. 8 illustrates an example permissions explorer graphical user interface (GUI) that may be generated by the system computing device, according to the present teachings.

FIG. 9 illustrates an example permissions explorer GUI that may be generated by the system computing device, according to the present teachings.

FIG. 10 illustrates an example permissions explorer GUI that may be generated by the system computing device, according to the present teachings.

FIG. 11 illustrates an example permissions explorer GUI that may be generated by the system computing device, according to the present teachings.

FIG. 12 illustrates an example data lineage GUI that may be generated by the system computing device, according to the present teachings.

FIG. 13 illustrates an example data lineage GUI that may be generated by the system computing device, according to the present teachings.

FIG. 14 illustrates an example data lineage GUI that may be generated by the system computing device, according to the present teachings.

FIG. 15 illustrates an example data classification GUI that may be generated by the system computing device, according to the present teachings.

FIG. 16 is a block diagram of a system computing device that may be implemented in conjunction with the computing system of FIG. 1, according to present teachings.

FIG. 17 is a flow diagram of a process 1700 for bounded agentic source code analysis using structural skeletons and large language model invocations, according to the present teachings.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing details that are pertinent to understanding the examples of the present disclosure so as not to obscure the disclosure with details that will be readily apparent to those of ordinary skill in the art having the benefit of the description herein.

### DETAILED DESCRIPTION

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a special purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

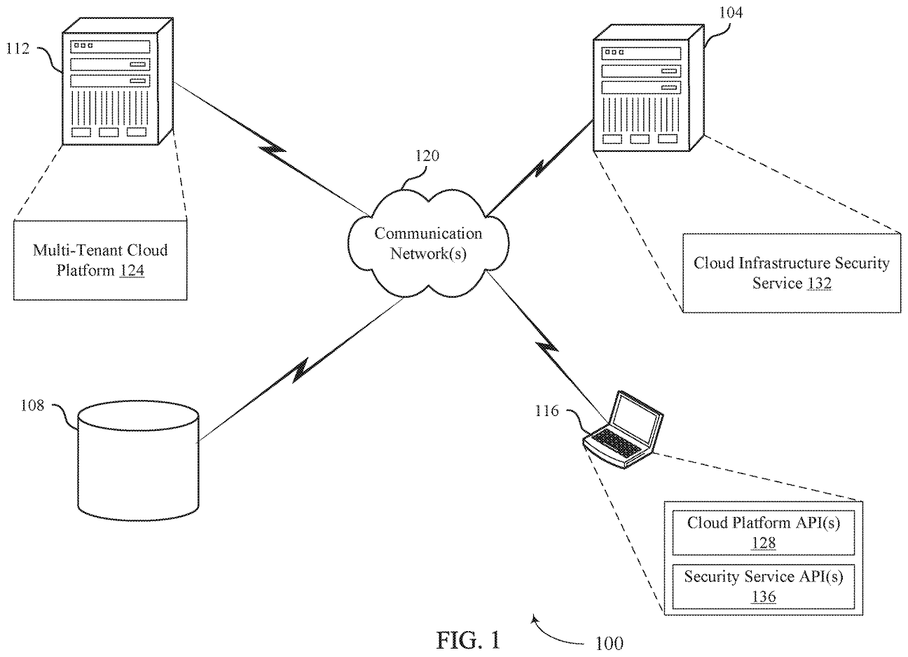

Referring now to FIG. 1, shown is an example computing environment 100, according to the present teachings. As shown, the computing environment 100 can include at least at least one system computing device 104, at least one database 108, at least one cloud platform server 112, and at least one client computing device 116, connected via at least one communications network 120.

The cloud platform server 112 may be adapted to provide a multi-tenant cloud platform 124 to, for example, the at least one client computing device 116. In that regard, the at least one client computing device 116 may include one or more cloud application programming interfaces (APIs) 128 to facilitate interactions with the multi-tenant cloud platform 124.

The multi-tenant cloud platform 124 may be a cloud-based software platform configured to provide services, data storage, configuration management, and application execution capabilities to a plurality of tenant organizations. As used herein, the term “tenant organization” may refer to a distinct organizational entity that operates within the multi-tenant cloud platform 124 under a separate configuration namespace, user permission structure, and data environment. The multi-tenant cloud platform 124 may expose one or more platform APIs 128 through which tenant organizations can interact with platform resources, manage configurations, assign user permissions, and access stored data. The multi-tenant cloud platform 124 may maintain platform-level metadata describing the configuration objects, user permission structures, data field definitions, and/or audit records associated with each tenant organization.

In some examples, the multi-tenant cloud platform 124 may be deployed in enterprise environments spanning a variety of industries and regulatory contexts. For example, the multi-tenant cloud platform 124 may be used by financial institutions to manage customer relationship data and financial services delivery subject to applicable financial regulatory requirements. In some examples, the multi-tenant cloud platform 124 may be used by healthcare organizations to manage patient data and health information subject to applicable health data privacy regulations. In some examples, the multi-tenant cloud platform 124 may be used by technology companies operating rapidly evolving environments with frequent configuration deployments and multiple third-party integrations. In some examples, the multi-tenant cloud platform 124 may be used by government agencies subject to strict security controls and rigorous compliance standards applicable to sensitive government data.

In some examples, the at least one client computing device 116 may interact with the multi-tenant cloud platform 124 via the one or more cloud platform APIs 128 to perform configuration management operations, assign or modify user permissions, deploy application components, and retrieve audit and metadata records associated with one or more tenant organizations. In some examples, the at least one client computing device 116 may include one or more user interfaces through which administrators, security engineers, and compliance personnel can initiate security assessments, define governance policies, review detected violations, and take remediation actions with respect to the multi-tenant cloud platform 124.

In some examples, the multi-tenant cloud platform 124 may be a customer relationship management (CRM) platform, such as Salesforce. com, that provides cloud-based services for sales, service, marketing, and application development across multiple tenant organizations. In such examples, the one or more cloud platform APIs 128 may include Salesforce Object Query Language (SOQL) interfaces, Metadata APIs, Tooling APIs, and Change Data Capture interfaces through which the cloud infrastructure security service 132 can retrieve configuration metadata, audit trail records, user permission assignments, and data field definitions associated with one or more connected Salesforce tenant organizations. In some examples, the multi-tenant cloud platform 124 may be any other cloud-based platform that exposes APIs for configuration management, user permission administration, and audit trail retrieval across multiple tenant organizations.

The system computing device 104 can provide a cloud infrastructure security service 132 designed to enforce governance and security policies, monitor configuration changes, classify sensitive data fields, analyze data lineage and user access structures, assess security posture against established baselines, and/or perform regulatory inference across one or more connected tenant organizations of the multi-tenant cloud platform 124. The cloud infrastructure security service 132 may be deployed as a service layer interposed between the at least one client computing device 116 and the multi-tenant cloud platform 124, such that the cloud infrastructure security service 132 can receive configuration metadata, audit trail records, and user permission data from the multi-tenant cloud platform 124 via the one or more cloud platform APIs 128, and can surface security findings, policy violations, and compliance assessments to the at least one client computing device 116 via the one or more security service APIs 136. In that regard, the at least one client computing device 116 may include one or more security service APIs 136 to facilitate interactions with the cloud infrastructure security service 132.

In some examples, the cloud infrastructure security service 132 may interact with the multi-tenant cloud platform 124 by periodically retrieving configuration metadata, user permission assignments, audit trail records, and/or data field definitions from the multi-tenant cloud platform 124 via the one or more cloud platform APIs 128. In some examples, the cloud infrastructure security service 132 may subscribe to configuration-change events published by the multi-tenant cloud platform 124, such that the cloud infrastructure security service 132 can detect and respond to changes in the configuration of one or more connected tenant organizations in near real time. In some examples, the cloud infrastructure security service 132 may interact with the at least one client computing device 116 by surfacing security findings, policy violation alerts, data classification results, risk assessment scores, and remediation recommendations via the one or more security service APIs 136 and associated user interfaces.

In some examples, database 108 may be used to store data related to the cloud infrastructure security service 132. The different types of data may be stored in a single database 108, separate databases, or any combination thereof. Database 108 may include any type of centralized database, distributed database, or the like. For example, a centralized database may reside in one central location which may be accessed by various users, computing devices, or applications via a network, such as the at least one network 120. In another aspect, a distributed database may be spread across multiple servers or nodes in a distributed database, and a user may retrieve data seamlessly, similar to if the data was stored within a centralized database.

In some examples, the one or more networks 120 may be at least one local area network (LAN), at least one wide area network (WAN), or other types of networks, supporting protocols like transmission control protocol/Internet protocol (TCP/IP) over Ethernet. In some instances, the one or more networks 120 may be a cloud network. The one or more communication networks 120 may serve as a system hub, providing computational resources and storage capabilities. The one or more communication networks 120 may include resources to manage and deliver computing services over the Internet or other communication forms. The one or more communication networks 120 may be executed within or as a virtual machine or a virtual server that may be managed in a cloud-based computing environment. Also, the application(s) may be located on one or more virtual server(s) running in a cloud-based computing environment rather than being tied to one or more specific physical network computing devices. For example, the application(s) may be running in one or more virtual machines (VMs). In some examples the one or more networks 120 may include elements such as data centers, virtualized resources, cloud services, and security tools. In some aspects, the one or more communication networks 120 may utilize data centers that also host servers capable of processing, storing, and managing network traffic, allowing centralized control without on-site hardware.

In some instances, the at least one network 120 may be a cloud network. The at least one network 120 may serve as a system hub, providing computational resources and storage capabilities. The at least one network 120 may include resources to manage and deliver computing services over the Internet or other communication form. The at least one network 120 may be executed within or as a virtual machine or a virtual server that may be managed in a cloud-based computing environment. Also, the application(s) may be located in one or more virtual server(s) running in a cloud-based computing environment rather than being tied to one or more specific physical network computing devices. For example, the application(s) may be running in one or more virtual machines (VMs). In some examples, the at least one network 120 may include elements such as data centers, virtualized resources, cloud services, and security tools. In some aspects, the at least one network 120 may utilize data centers that also host servers capable of processing, storing, and managing network traffic, allowing centralized control without on-site hardware.

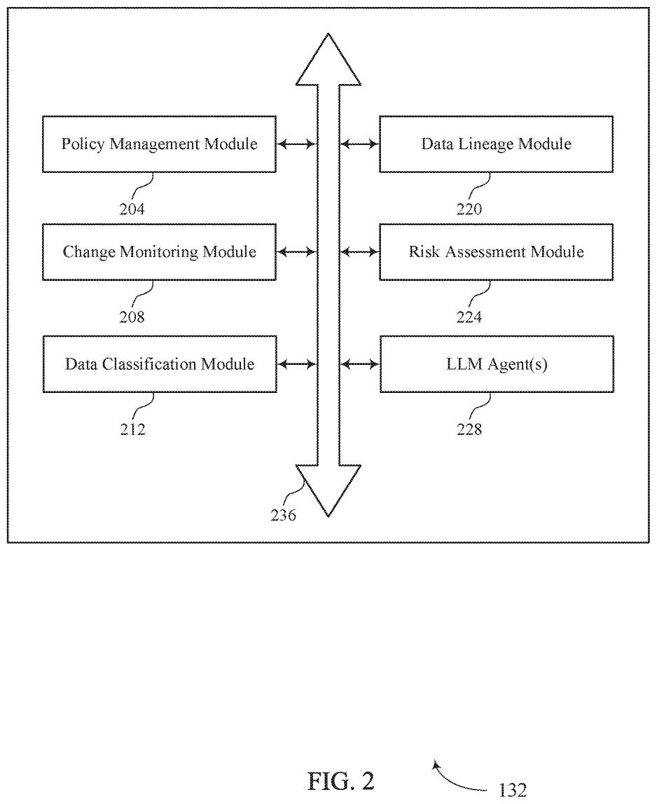

FIG. 2 is a block diagram of a cloud infrastructure security service 132 that supports automated security posture management, policy enforcement, data classification, and compliance monitoring for multi-tenant cloud infrastructure, according to the present teachings. In some cases, the cloud infrastructure security service 132 may be implemented as part of one or more processors. The cloud infrastructure security service 132 may also be provided in the form of a single module or separate modules, as described within FIG. 1. In some instances, the cloud infrastructure security service 132 may be a single device (e.g., system computing device 104) that includes separate components or modules as shown in the example of FIG. 1. However, in other instances, the cloud infrastructure security service 132 may be part of a collection of individual devices, wherein each device may include one or more modules.

The cloud infrastructure security service 132 may include, without limitation, a policy management module 204, a change monitoring module 208, a data classification module 212, a data lineage module 220, a risk assessment module 224, and one or more large language model (LLM) agents 228.

The policy management module 204 may be designed to receive natural-language policy intent from an authoring user, compile the policy intent into machine-enforceable configuration-validation rules using one or more LLM agents 228, apply the compiled rules against configuration metadata of one or more connected tenant organizations of the multi-tenant cloud platform 124, and/or record deviation findings when rule violations are detected. In some examples, the policy management module 204 may maintain a three-tier data model comprising a policy intent tier, a validation rule tier, and a deviation finding tier, wherein each deviation finding is identified by a three-tuple origin identifier comprising an organization identifier, a metadata-object name, and a validation-rule identifier. In some examples, the policy management module 204 may interact with the multi-tenant cloud platform 124 via the one or more cloud platform APIs 128 to retrieve configuration metadata for rule evaluation, and may interact with the at least one client computing device 116 via the one or more security service APIs 136 to surface policy violation alerts and remediation recommendations to administrators and security personnel.

The change monitoring module 208 may be designed to provide a comprehensive audit trail of configuration changes made within one or more connected tenant organizations of the multi-tenant cloud platform 124. In some examples, the change monitoring module 208 may retrieve audit trail records from the multi-tenant cloud platform 124 via the one or more cloud platform APIs 128, enrich raw audit events into structured objects comprising contextual metadata such as the identity of the user who made the change, the timestamp of the change, the metadata type and record name affected, the type of operation performed, and an assigned risk level, and present the enriched change records to the at least one client computing device 116 via the one or more security service APIs 136. In some examples, the change monitoring module 208 may support advanced filtering by user, time range, and metadata type, and may generate email notifications when changes matching user-defined criteria are detected. In some examples, the change monitoring module 208 may interact with the policy management module 204 via a policy enforcement component that compares detected changes against active policies and triggers remediation actions when violations are identified.

In some examples, the change monitoring module 208 may retrieve audit trail records from the multi-tenant cloud platform 124 by using a Tooling API exposed by the multi-tenant cloud platform 124 to access a full setup audit trail log containing up to six months of historical data maintained by the multi-tenant cloud platform 124.

In some examples, the change monitoring module 208 may enrich raw audit trail events by performing regex-based parsing of raw event data, executing real-time queries to the multi-tenant cloud platform 124 via the one or more cloud platform APIs 128 to gather additional metadata details, and/or categorizing each change based on predefined change types such as profile modifications, security changes, and/or the like. For example, a raw audit trail event comprising a simple string representation of a change, such as a permission set assignment event, may be transformed by the change monitoring module 208 into a structured object comprising fields such as a detail field, a login identifier, an audit trail identifier, a date timestamp, an event key, a record name, a property modified indicator, a sub-property modified indicator, a before value, an after value, a change category, a record identifier, a metadata type, an operation type, a metadata indicator, and/or a risk level.

By way of example, a raw audit trail event retrieved from the multi-tenant cloud platform 124 may comprise the unstructured string Permission Set Omega assigned to jdoe@example.com by admin@example.com on 2026-04-15 09:32. The change monitoring module 208 may parse the raw event and emit a structured object comprising:

```
{
  “auditTrailId”: “0Ab1A000000Xyz1”,
  “date”: “2026-04-15T09:32:00Z”,
  “loginIdentifier”: “admin@example.com”,
  “metadataType”: “PermissionSetAssignment”,
  “operationType”: “ASSIGN”,
  “recordName”: “Permission Set Omega”,
  “propertyModified”: “assignee”,
  “afterValue”: “jdoe@example.com”,
  “changeCategory”: “ACCESS_CONTROL”,
  “riskLevel”: “HIGH”
}
```

The structured object can enable filtered retrieval, notification dispatch, and policy evaluation by metadata type, operation type, change category, and risk level, which may not be otherwise available from the unstructured raw event.

In some examples, the change monitoring module 208 may store up to one year of historical audit trail data, exceeding the six-month retention limit imposed by the native audit trail functionality of the multi-tenant cloud platform 124.

The data classification module 212 may be designed to scan custom data fields defined within one or more connected tenant organizations of the multi-tenant cloud platform 124, classify those fields according to applicable regulatory frameworks such as the General Data Protection Regulation (GDPR), the Health Insurance Portability and Accountability Act (HIPAA), the Payment Card Industry Data Security Standard (PCI-DSS), and the California Consumer Privacy Act (CCPA), and surface classification results and recommendations to the at least one client computing device 116. In some examples, the data classification module 212 may operate in two phases: a first phase in which field-metadata descriptors are retrieved and submitted to one or more LLM agents 228 for metadata-level classification using tenant-scoped regulatory vocabularies and keyword sets, and a second phase in which a deterministic gating function selectively admits fields for deep-value classification based on the first-phase classification output, the field data type, and the tenant keyword set. In some examples, the data classification module 212 may interact with the multi-tenant cloud platform 124 via the one or more cloud platform APIs 128 to retrieve field metadata and record-level data samples, and may interact with the at least one client computing device 116 via the one or more security service APIs 136 to surface classification reports and auto-remediation options.

In some examples, the data classification module 212 may update the multi-tenant cloud platform 124 directly via the one or more cloud platform APIs 128 to add data classifications to fields identified as containing or potentially containing sensitive data, thereby enabling auto-remediation of unclassified fields without requiring manual intervention by an administrator.

The data lineage module 220 may be designed to answer questions about sensitive and classified data fields within one or more connected tenant organizations of the multi-tenant cloud platform 124, including identifying which users have access to a given sensitive data field, which Salesforce metadata components reference that field, and what percentage of records within the tenant organization contain data populated in that field. In some examples, the data lineage module 220 may retrieve field-level metadata, user permission assignments, and record-level usage statistics from the multi-tenant cloud platform 124 via the one or more cloud platform APIs 128, and may surface field insight reports to the at least one client computing device 116 via the one or more security service APIs 136. In some examples, the data lineage module 220 may interact with the policy management module 204 to enable the automatic creation of governance policies based on field access findings identified through data lineage analysis.

In some examples, the data lineage module 220 may retrieve record-level usage statistics from the multi-tenant cloud platform 124 via the one or more cloud platform APIs 128 to determine what percentage of records within a tenant organization contain data populated in a given classified field. The data lineage module 220 may surface the percentage of usage, the total number of records of the relevant object type, and/or the number of records containing a non-null value in the classified field to the at least one client computing device 116 via the one or more security service APIs 136.

The risk assessment module 224 may be designed to perform a comprehensive scan of the security posture of one or more connected tenant organizations of the multi-tenant cloud platform 124 by comparing the security settings of each tenant organization against a predefined security baseline, identifying settings that are noncompliant with the baseline, and generating a compliance score reflecting the proportion of compliant settings relative to the total number of evaluated settings. In some examples, the risk assessment module 224 may categorize identified risks into those that can be resolved automatically through the cloud infrastructure security service 132 and those that require manual remediation by an administrator, and may provide step-by-step remediation guidance for each identified risk. In some examples, the risk assessment module 224 may interact with the multi-tenant cloud platform 124 via the one or more cloud platform APIs 128 to retrieve current security settings, and may interact with the at least one client computing device 116 via the one or more security service APIs 136 to surface risk assessment results, compliance scores, and remediation options.

In some examples, the risk assessment module 224 may perform each security posture scan in real time responsive to a user actively viewing the risk assessment results, and may store the scan results in memory rather than in a persistent database, such that each scan reflects the current state of the security settings of the tenant organization at the time of the scan.

In some examples, the predefined security baseline used by the risk assessment module 224 may be derived from a health check baseline provided by the multi-tenant cloud platform 124. In some examples, the multi-tenant cloud platform 124 may permit users to define custom baseline configurations by uploading a custom XML file specifying recommended values and risk classifications for individual security settings. Where no custom XML file has been uploaded, the risk assessment module 224 may use the default health check baseline provided by the multi-tenant cloud platform 124.

By way of illustration, a custom XML file uploaded by an authoring user to specify a tenant-specific security baseline may comprise a document such as:

```
xml
<SecurityBaseline version=“1.0”>
  <Setting id=“PasswordPolicies.MinPasswordLength”>
    <RecommendedValue>12</RecommendedValue>
    <RiskClassification>HIGH_RISK</RiskClassification>
  </Setting>
  <Setting id=“SessionSettings.SessionTimeout”>
    <RecommendedValue>30</RecommendedValue>
    <RiskClassification>MEDIUM_RISK</RiskClassification>
  </Setting>
  <Setting id=“SessionSettings.RequireHttpsOnly”>
    <RecommendedValue>true</RecommendedValue>
    <RiskClassification>HIGH_RISK</RiskClassification>
  </Setting>
</SecurityBaseline>
```

The baseline upload endpoint can validate the XML document against the baseline schema, parse the document into a baseline configuration record comprising three setting entries, and persist the baseline configuration record in association with the connected tenant organization. Subsequent risk assessment scans can evaluate the security settings of the tenant organization against the persisted baseline rather than against the default health check baseline provided by the multi-tenant cloud platform 124.

In some examples, the risk assessment module 224 may enable single-click auto-remediation of certain noncompliant security settings, such as password policy settings and/or session settings, by updating the noncompliant settings directly via a Tooling API of the multi-tenant cloud platform 124 rather than via a health check risks API. In some examples, other security settings, such as sharing settings and/or file upload configurations, may require manual remediation by an administrator due to the customer-specific decision-making involved in resolving those settings.

In some examples, the compliance score generated by the risk assessment module 224 may be computed as the ratio of the number of compliant settings to the total number of evaluated settings, expressed as a percentage. In some examples, the compliance score may be unweighted, such that each evaluated security setting may be treated equally regardless of the severity or category of the setting. In some examples, the risk assessment module 224 may evaluate additional security settings beyond those included in the native health check of the multi-tenant cloud platform 124, which may cause the compliance score to differ from a score computed by the native health check functionality.

By way of example, a risk assessment scan that evaluates a connected tenant organization against a baseline of fifty (50) security settings and identifies forty-three (43) settings as compliant and seven (7) settings as non-compliant can produce a compliance score of 43/50=86%. Each of the fifty evaluated settings may contribute equally to the compliance score regardless of the severity classification of the setting. Under the unweighted property, a single non-compliant setting classified as HIGH_RISK can contribute the same 1/50=2% reduction in the compliance score as a single non-compliant setting classified as LOW_RISK. The severity classification of each non-compliant setting can be surfaced separately in the per-finding remediation guidance presented to the at least one client computing device 116.

The one or more LLM agents 228 may be invoked by, for example, the policy management module 204, the data classification module 212, the data lineage module 220, and/or the risk assessment module 224. In that regard, the one or more LLM agents 228 may be designed to compile natural-language policy intent into machine-enforceable validation rules, classify sensitive data fields according to tenant-scoped regulatory vocabularies, infer applicable regulatory control citations from policy intent text, perform source code analysis using bounded context retrieval architectures, and generate structured findings consumable by downstream rule-based automation. In some examples, the one or more LLM agents 228 may operate under structured-output constraints such that outputs non-conforming to a defined schema trigger automatic re-prompting with error context before the outputs are persisted or acted upon.

In some examples, the components of the cloud infrastructure security service 132 may be interconnected and communicate via a bus 236. The bus 236 may enable communication via any standard or specification such as peripheral component interconnect, peripheral component interconnect express, parallel advanced technology attachment, or serial advanced technology attachment. The at least one bus 236 may be provided in the form of a single bus or multiple buses that are operatively interconnected.

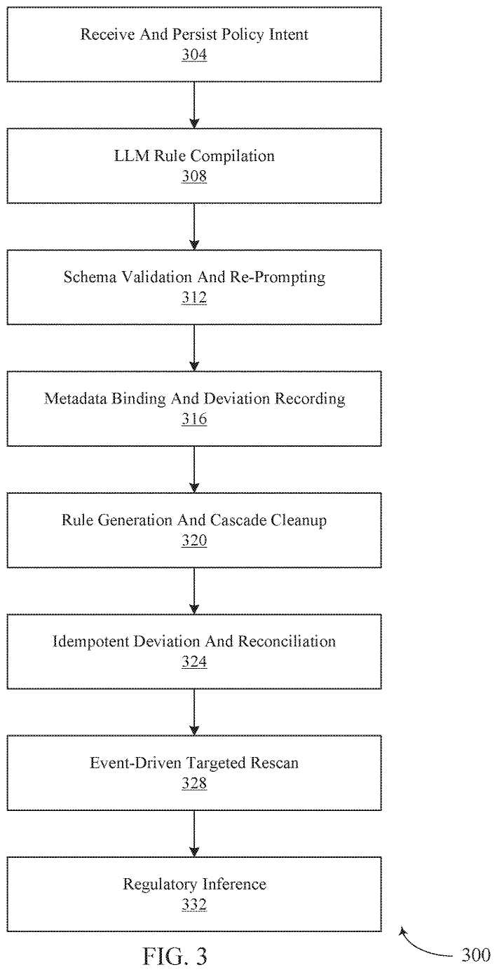

FIG. 3 is a flow diagram of a process 300 for machine-enforced multi-tenant configuration compliance, according to the present teachings. Although the process steps are described with reference to the systems and processes of FIGS. 1-2, persons skilled in the art will understand that any system adapted to implement the method steps, in any order, falls within the scope of the present invention. Operations of the process 300 can be performed by one or more components of the cloud infrastructure security service 132. For example, one or more operations of the process 300 may be performed by the policy management module 204 and/or the change monitoring module 208 described with reference to FIG. 2.

In some examples, the process 300 is performed when an authoring user, such as a security administrator or compliance engineer, creates or modifies a security governance policy within the cloud infrastructure security service 132, or when a configuration-change event is received from a connected tenant organization of the multi-tenant cloud platform 124 that may implicate an active policy.

At step 304, the process 300 can include receiving and persisting a policy intent. For example, the policy management module 204 can receive, from an authoring user, a policy intent comprising a natural-language string expressing a desired security or governance condition for one or more connected tenant organizations of the multi-tenant cloud platform 124, and can persist the policy intent as a first-tier artifact in a policy-intent data store together with metadata regarding authorship and version.

At step 308, the process 300 can include LLM rule compilation. For example, the policy management module 204 can invoke one or more LLM agents 228 with the persisted policy intent and a structured-output prompt template to generate a corpus of validation rules, each validation rule comprising a rule body bounded to no more than a predetermined atomic character length, an associated target-metadata-type identifier identifying the type of configuration metadata against which the rule is to be evaluated, and a human-readable explanation for administrative display. In some examples, the bounded character length of each rule body may be no more than fifty (50) characters, a constraint that may cause the one or more LLM agents 228 to decompose complex policy intent into atomic units each of which maps to a single metadata-object evaluation.

In some examples, the bounded character length of each rule body may be enforced both (i) by an instruction included in the structured-output prompt template provided to the one or more LLM agents 228 and (ii) by a server-side validation constraint applied at the persistence boundary, such that any rule body exceeding the bounded character length is rejected before being persisted as a validation rule record.

As an example, a candidate rule body of the form permissions. ModifyAllData==false (thirty-three characters) can fall within the bounded character length, while a candidate rule body of the form permissions. ModifyAllData==false AND permissions. ViewAllData==false (sixty-six characters) can exceed the bound and is, in some examples, decomposed by the one or more LLM agents 228 into two atomic rules each falling within the bound.

As an example, a policy intent reciting “Profiles must require multi-factor authentication and must not grant the Modify All Data permission” may be compiled by the one or more LLM agents 228 into a corpus of two validation rules each bounded to a maximum number of characters (e.g., 50 characters). The first rule may a rule body such as requireMfa==true (eighteen characters) and the second rule may include a rule body such as permissions. ModifyAllData==false (thirty-three characters). In contrast, a non-conforming candidate rule body such as permissions. ModifyAllData==false AND modifiedBy in adminGroup (sixty characters) would exceed the bounded character length and would, in some examples, be rejected by the server-side validation constraint and returned to the one or more LLM agents 228 for decomposition into two atomic rules each falling within the bound.

At step 312, the process 300 can include schema validation and re-prompting. For example, the policy management module 204 can validate the output of the LLM rule compilation of step 308 against a predefined schema to confirm that each generated validation rule conforms to the required structure, including the bounded rule body, the target-metadata-type identifier, and the human-readable explanation. In some examples, where the LLM output does not conform to the schema, the policy management module 204 can automatically re-invoke the one or more LLM agents 228 with the non-conforming output and associated error context to obtain a conforming rule corpus before persisting the rules.

In some examples, the structured-output schema validation performed by the policy management module 204 may produce, upon detection of a non-conforming output, a structured error context comprising at least (i) a JSON path identifying the location of the violation within the language-model output, (ii) a fragment of the validation schema corresponding to the violated constraint, and (iii) the prior non-conforming output. The structured error context may be incorporated into the re-prompt template provided to the one or more LLM agents 228, such that successive re-prompts converge toward a schema-conforming rule corpus within a bounded number of iterations. In some examples, the bounded number of iterations may default to three (3) iterations.

At step 316, the process 300 can include metadata binding and deviation recording. For example, the policy management module 204 can apply each validated rule against live configuration metadata of one or more connected tenant organizations of the multi-tenant cloud platform 124, retrieved via the one or more cloud platform APIs 128, and can record any rule violation as a deviation finding in a third-tier deviation data store. Each deviation finding may be identified by a three-tuple origin identifier comprising an organization identifier, a metadata-object name, and a validation-rule identifier, such that the three-tuple origin identifier may serve as a uniqueness key to support idempotent deviation management across successive rescans.

At step 320, the process 300 can include rule regeneration and cascade cleanup responsive to a policy edit. For example, responsive to an edit to a persisted policy intent, the policy management module 204 can re-invoke the one or more LLM agents 228 with the updated policy intent text to produce an updated rule corpus, compute a differential between the updated rule corpus and the prior rule corpus, remove from the validation rule data store any rules present in the prior corpus but not present in the updated corpus, and cascade-delete from the deviation data store any deviation findings whose three-tuple origin identifier references a removed rule, all within a single atomic database transaction. In some examples, any rules present in the updated corpus but not in the prior corpus may be persisted as new rule records and enqueued for evaluation against the configuration metadata of connected tenant organizations.

By way of example, a policy intent comprising the text “Profiles must require multi-factor authentication” may be compiled into a single validation rule with rule identifier R-MFA-01 against which two deviation findings have been recorded for two non-conforming profiles. In such an example, responsive to an edit of the policy intent text to “Profiles assigned to system administrators must require multi-factor authentication”, the policy management module 204 may re-invoke the one or more LLM agents 228 to produce an updated rule corpus, may compute a differential, may remove rule R-MFA-01 from the validation rule data store, and may cascade-delete both associated deviation findings. Such actions may be performed within a single atomic database transaction. A new rule with rule identifier R-MFA-02 reflecting the narrower intent may be persisted and enqueued for evaluation.

At step 324, the process 300 can include idempotent deviation reconciliation. For example, on each scan, the policy management module 204 can create or update a deviation record keyed by the three-tuple origin identifier comprising the organization identifier, the metadata-object name, and the validation-rule identifier. In some examples, where a previously observed three-tuple is no longer produced by a subsequent scan, the policy management module 204 can automatically transition the corresponding deviation record from an open state to a resolved state, such that the three-tuple origin identifier may support idempotency of deviation records across arbitrary rescan cadences.

As an example, a deviation finding produced by applying a validation rule with rule identifier R-MFA-01 to a profile metadata object named Standard_Admin within a tenant organization having organization identifier 00DABC123456789 may be persisted under the three-tuple origin identifier (e.g., 00DABC123456789, Standard_Admin, R-MFA-01). On a subsequent rescan in which the same three-tuple is again produced, the existing deviation record can be updated in place rather than duplicated. On a rescan in which the same three-tuple is no longer produced, such as instances where a Standard_Admin profile has been corrected to require multi-factor authentication, the deviation record can be automatically transitioned from an open state to a resolved state, thereby preserving the historical record while reflecting the current compliance posture.

At step 328, the process 300 can include event-driven targeted rescan. For example, the policy management module 204 can subscribe to tenant-scoped configuration-change events published by the multi-tenant cloud platform 124, such as Change Data Capture events, metadata-change events, and setup audit trail events. Upon receipt of a configuration-change event originating from a specific tenant organization and describing a change to a specific metadata type, the policy management module 204 can retrieve the subset of validation rules whose associated target-metadata-type identifier matches the changed metadata type and execute only those rules against the specific tenant organization, thereby bounding the rescan cost to the rules and metadata objects relevant to the detected change rather than performing a full cross-product scan.

At step 332, the process 300 can include regulatory inference. For example, contemporaneously with the initial persistence of a policy intent at step 304, the policy management module 204 can invoke one or more LLM agents 228 with a second prompt template to infer, from the natural-language policy intent text, a set of regulatory control citations applicable to each connected tenant organization, including enumerated regulatory sub-section identifiers such as HIPAA 45 C.F.R. § 164.312, PCI DSS requirements, SOC 2 Trust Services Criteria, and ISO/IEC 27001 Annex A controls. In some examples, the inferred citation set may be aggregated across all connected tenant organizations bound to the authoring parent organization to produce a federated compliance-surface data structure indicating, for each tenant organization, which regulatory controls the policy intent purports to satisfy.

In some examples, the federated compliance-surface data structure produced at step 332 may be rendered in a user interface presented to the at least one client computing device 116 via the one or more security service APIs 136 as a per-policy matrix of tenant organizations versus control citations, enabling the authoring user to observe, for a single authored policy intent, the cross-tenant regulatory impact across all connected tenant organizations.

In some examples, the policy management module 204 may present, via the one or more security service APIs 136 to the at least one client computing device 116, a display that provides, for each deviation record, the human-readable explanation of the associated validation rule together with the natural-language text of the originating policy intent, thereby preserving end-to-end traceability from a deviation finding to the authoring user intent that gave rise to the validation rule.

The process 300 may enable a closed-loop pipeline from natural-language policy authoring to machine-enforced, multi-tenant, regulation-aware configuration compliance. By maintaining a three-tier data model with cascade-delete constraints between tiers, the process 300 may prevent orphan deviation findings from arising when policy intent is edited, a condition that prior-art policy-as-code systems address only through separate manual cleanup. By executing only the subset of validation rules relevant to a detected configuration change, the process 300 may bound rescan cost relative to full cross-product rescans. By performing regulatory inference at authoring time rather than at evidence-collection time, the process 300 may surface applicable regulatory control citations before any evidence collection occurs, enabling proactive compliance awareness across federated tenant organizations.

In some examples, the three-tier data model maintained by the policy management module 204 may be implemented in a relational database with row-level tenant isolation, wherein each tier may be linked to the predecessor tier by a foreign-key reference and a cascading-delete constraint, such that deletion of a policy intent record may automatically cascade to the associated validation rule records and deviation finding records.

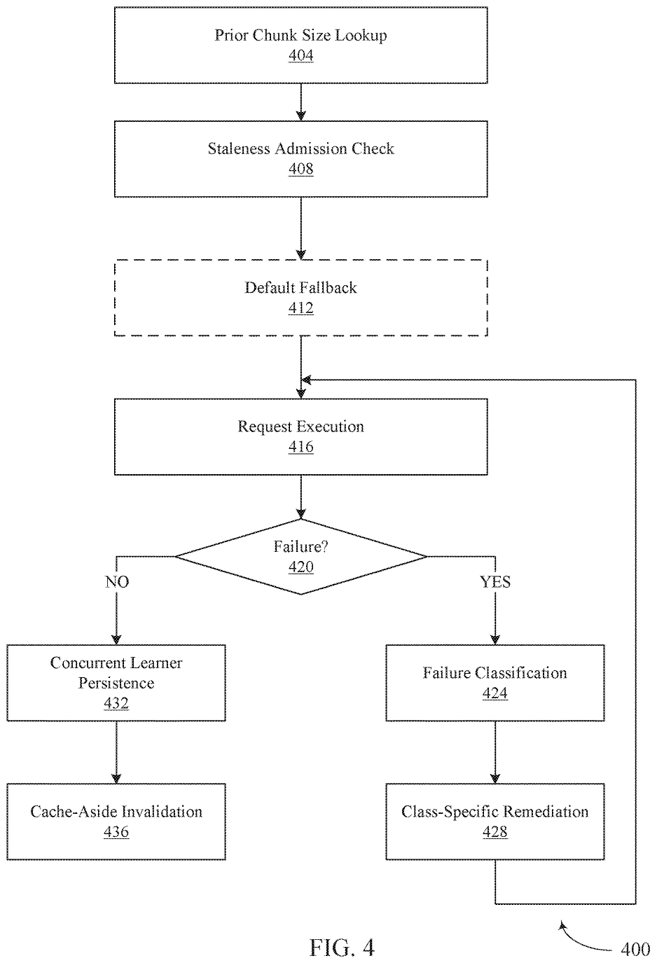

FIG. 4 is a flow diagram of a process 400 for executing batched requests against a remote API subject to request-size limits, according to the present teachings. Although the process steps are described with reference to the systems and processes of FIGS. 1-3, persons skilled in the art will understand that any system adapted to implement the method steps, in any order, falls within the scope of the present invention. Operations of the process 400 can be performed by one or more components of the cloud infrastructure security service 132. For example, one or more operations of the process 400 may be performed by the change monitoring module 208 and/or the data lineage module 220 described with reference to FIG. 2.

In some examples, the process 400 is performed when the cloud infrastructure security service 132 executes a batched request against an external API of the multi-tenant cloud platform 124, such as a SOQL query or a REST endpoint call that enumerates a plurality of record identifiers, and the maximum admissible request size for that operation is not known in advance or may have changed since the last successful execution.

At step 404, the process 400 can include a prior chunk size lookup. For example, the cloud infrastructure security service 132 can compute a composite key comprising a tenant identifier, an organization identifier, and an operation identifier, and can query a persistent store fronted by an in-process cache to retrieve a previously learned chunk size associated with that composite key. As used herein, the term “chunk size” may refer to the number of input items, such as record identifiers, included in a single batched request to the external API. In some examples, no learned chunk size may be shared across distinct values of the composite key, such that tenant, organization, and operation isolation may be maintained against adverse data shapes observed in any other composite key.

At step 408, the process 400 can include a staleness admission check. For example, the cloud infrastructure security service 132 can admit a retrieved prior chunk size as the starting chunk size for the current operation only if the timestamp associated with the prior chunk size is within a configured maximum age. In some examples, the configured maximum age may default to thirty (30) days. In some examples, a prior chunk size whose associated timestamp exceeds the configured maximum age may be treated as absent, causing the process 400 to proceed to the default fallback of step 412, such that the cloud infrastructure security service 132 may re-learn an appropriate chunk size to absorb any drift in tenant data shape or gateway configuration that may have occurred since the prior chunk size was recorded.

As an example, a learned chunk size persisted on 2026-01-01 and queried on 2026-01-20 can fall within the thirty-day staleness window and be admitted as the starting chunk size for the current operation. A learned chunk size persisted on 2026-01-01 and queried on 2026-02-15 can exceed the thirty-day staleness window, be treated as absent, and can trigger re-learning from the caller-supplied default chunk size at step 412.

At step 412, the process 400 can include a default fallback. For example, where no admissible prior chunk size exists, either because no prior chunk size has been recorded for the composite key or because the prior chunk size has been determined to be stale at step 408, the cloud infrastructure security service 132 can start from a caller-supplied default chunk size and may mark a write-back as needed upon successful completion of the request execution of step 416.

At step 416, the process 400 can include request execution. For example, the cloud infrastructure security service 132 can invoke a caller-supplied function with the current chunk size, the function being configured to construct and issue a batched request to the external API of the multi-tenant cloud platform 124 through an intermediate gateway. In some examples, the batched request may take the form of a SOQL query enumerating a plurality of record identifiers in a WHERE Id IN clause, or a POST body enumerating a plurality of identifiers, the size of which is bounded by the current chunk size.

In some examples, the caller-supplied function accepted by the cloud infrastructure security service 132 at step 416 may comprise a function that accepts an integer chunk size parameter and returns a result of executing a single batched request using that chunk size. The caller of the function need not implement retry logic, persistence logic, or lock behavior, as the process 400 may encapsulate the adaptive retry, persistence, and concurrent-learner locking behavior on behalf of the caller.

At step 420, the process 400 can include failure detection. For example, the cloud infrastructure security service 132 can determine whether the request execution of step 416 resulted in a failure. In some examples, where a failure is detected, the cloud infrastructure security service 132 can classify the failure at step 424 to determine whether the failure is attributable to a request-size-limit rejection by the intermediate gateway or the external API. In some examples, failure classification may be performed by inspecting the response body of the failure for one or more predetermined textual markers injected into the response body by the intermediate gateway to indicate a request-size-limit rejection, such as markers corresponding to HTTP status codes 413, 414, and/or 431.

At step 424, the process 400 can include, responsive to a detected failure of the request execution (YES at step 420), failure classification. For example, the cloud infrastructure security service 132 can inspect the response body of the failure for one or more predetermined textual markers injected by the intermediate gateway to indicate a request-size-limit rejection. In some examples, where the failure is not classified as a request-size-limit rejection, the cloud infrastructure security service 132 can rethrow the failure without retry. In some examples, where the failure is classified as a request-size-limit rejection and the current chunk size is at or below a configured floor, the cloud infrastructure security service 132 can rethrow the failure without further size reduction.

In some examples, the intermediate gateway disposed between the cloud infrastructure security service 132 and the multi-tenant cloud platform 124 may perform a method comprising receiving a request from the cloud infrastructure security service 132 addressed to the external API, detecting that the request or a response to the request exceeds a request-size limit imposed by the gateway, by a transport layer, or by the external API, constructing a response having a response body containing a predetermined textual marker corresponding to the violated size-limit class that is distinct from the outer HTTP status code of the response, and returning the constructed response to the cloud infrastructure security service 132. In some examples, the predetermined textual marker may be recognizable by the cloud infrastructure security service 132 to trigger the size-shrinking retry behavior of step 428 keyed on the composite key comprising the tenant identifier, the organization identifier, and the operation identifier.

In some examples, the intermediate gateway disposed between the cloud infrastructure security service 132 and the multi-tenant cloud platform 124 may be implemented as a middleware component within an application programming interface gateway service that intercepts requests addressed to the multi-tenant cloud platform 124. The middleware component may detect request-size or response-size violations at one or more of: (i) the application layer, by inspecting an outer HTTP status code returned by the multi-tenant cloud platform 124 and matching the outer HTTP status code against a set comprising HTTP status codes 413, 414, and 431; (ii) the transport layer, by detecting transport-layer errors such as a header-length-overflow error; and (iii) a request-construction stage prior to transmission, by comparing the size of the request to be transmitted against a configured request-size threshold. Responsive to detection of a request-size or response-size violation, the middleware component may construct a response body comprising a predetermined textual marker selected from a set comprising “ERROR_HTTP_413”, “ERROR_HTTP_414”, and “ERROR_HTTP_431”, and may return the constructed response to the cloud infrastructure security service 132. The predetermined textual marker may be recognizable by the cloud infrastructure security service 132 to trigger the size-shrinking retry behavior of step 428.

By way of example, a response body returned by the intermediate gateway responsive to detection of a Uniform Resource Identifier exceeding a configured length limit may comprise a JavaScript Object Notation document such as:

```
{
  “errorCode”: “ERROR_HTTP_414”,
  “message”: “Request-URI Too Long”,
  “upstreamStatus”: 414,
  “operationKey”: “QueryRecordsById”,
  “requestSize”: 18432,
  “limit”: 16384
}
```

A textual marker ERROR_HTTP_414 within the response body can be recognizable by the cloud infrastructure security service 132 by, for example, application of a regular expression of the form ERROR_HTTP_(413|414|431) to the response body. In some examples, the presence of the marker may trigger a size-shrinking retry behavior of step 428, while the outer HTTP status code remains available for observability and logging.

At step 428, the process 400 can include class-specific failure remediation. For example, where the failure is classified as a request-size-limit rejection and the current chunk size exceeds the configured floor, the cloud infrastructure security service 132 can compute a next chunk size by halving the current chunk size bounded below by the configured floor, and can iterate by returning to step 416 with the reduced chunk size. In some examples, the halving-with-floor shrink strategy may guarantee monotonic non-increasing chunk size and termination within O(log(defaultChunkSize/floor)) iterations, where defaultChunkSize is the caller-supplied default chunk size and floor is the configured floor value.

As an example, given a default chunk size of two hundred (200) and a configured floor of three (3), a maximum number of shrink iterations performed within a single invocation of the process 400 may be bounded above by ceil(log_2(200/3))+1=7. The corresponding shrink sequence can proceed as 200→100→50→25→12→6→3, terminating either at the first successful chunk size or at the configured floor of three. In contrast, an unbounded shrink strategy without a configured floor may iterate indefinitely under adverse data shapes. The halving-with-floor strategy described herein can therefore enable termination within a logarithmic number of iterations.

In some examples, the chunk size may not be increased on success within a single invocation of the process 400. The cloud infrastructure security service 132 may perform only monotonic non-increasing adjustments to the chunk size within a single invocation, such that the chunk size may decrease or remain unchanged but may not increase during the execution of the bounded shrink loop of steps 416 through 428.

At step 432, the process 400 can include, responsive to a detected success of the request execution (NO at step 420), concurrent learner persistence. For example, where the successful chunk size differs from the chunk size recorded in the persistent store for the composite key, or where no prior chunk size existed, the cloud infrastructure security service 132 can attempt to acquire a non-blocking distributed lock keyed on the composite key. In some examples, responsive to successful lock acquisition, the cloud infrastructure security service 132 can upsert the successful chunk size with a fresh timestamp into the persistent store. In some examples, where lock acquisition fails, the cloud infrastructure security service 132 can silently proceed without persisting the chunk size, in reliance on the invariant that any concurrent service instance acquiring the lock may persist an equally valid chunk size.

In some examples, the persistent store used by the cloud infrastructure security service 132 to store learned chunk sizes may comprise a relational table having columns for an organization identifier of type UUID, an operation key of type variable-length character string, a chunk size of type integer, and an updated-at timestamp, with a primary key comprising the organization identifier and the operation key. In some examples, the tenant identifier may be an ambient multi-tenant context derived from the session of the caller and may be incorporated into the cache key to provide tenant isolation at the cache layer.

At step 436, the process 400 can include cache-aside invalidation. For example, upon persisting a new chunk size at step 432, the cloud infrastructure security service 132 can evict the in-process cache entry associated with the composite key, such that subsequent reads may observe the newly persisted chunk size rather than a stale cached value.

The process 400 may enable execution of batched requests against an external API subject to request-size limits with reduced hot-path latency, without per-tenant human configuration, with correct behavior under horizontal scale-out across multiple service instances learning concurrently, and with self-healing behavior when tenant data shape or gateway configuration drifts. By persisting a learned chunk size keyed on a composite tuple of tenant identifier, organization identifier, and operation identifier, the process 400 may eliminate per-call probing overhead after an initial learning episode. By classifying failures using gateway-injected body markers rather than outer HTTP status codes, the process 400 may remain correct even when the intermediate gateway maps multiple upstream errors to a single outer status code.

In some examples, the concurrent-learner persistence behavior of the process 400 may be illustrated by a worked example in which a multi-tenant service runs four pods and a tenant invokes an operation for the first time with a default chunk size of two hundred (200). In such an example, a first pod may execute a request with chunk size 200, receive a size-limit rejection, halve to 100, receive a second size-limit rejection, halve to 50, succeed, acquire the distributed lock via a non-blocking tryLock operation, and persist the learned chunk size of 50. A second pod, executing concurrently, may independently learn a chunk size of 50 through the same halving sequence, attempt to acquire the distributed lock, fail to acquire the lock, and silently proceed without persisting, in reliance on the invariant that the first pod has persisted an equally valid value. A third pod, executing ten seconds later, may experience a cache miss, read the persisted chunk size of 50 from the persistent store, execute a request with chunk size 50, succeed on the first attempt, and perform no write-back because the successful chunk size matches the stored value. A fourth pod, executing thirty-one days later, may read the persisted chunk size of 50 from the persistent store but determine that the associated timestamp exceeds the configured staleness bound of thirty days, treat the prior chunk size as absent, start from the default chunk size of 200, and re-learn an appropriate chunk size through the bounded shrink loop.

In some examples, a fifth pod executing concurrently with the first pod may issue a request with chunk size two hundred (200), receive a size-limit rejection bearing the textual marker ERROR_HTTP_413 in the response body, halve to one hundred (100), succeed on the second attempt, and attempt to acquire the distributed lock keyed on (tenantA, 00DABC123456789, QueryRecordsById). In such examples, because the first pod has already persisted a chunk size of fifty (50) under the same composite key, the fifth pod may either (i) succeed in acquiring the lock and overwrite the persisted value of fifty with the value of one hundred or (ii) fail to acquire the lock and silently proceed without persisting, in reliance on the invariant that any concurrent service instance acquiring the lock has persisted an equally valid chunk size.

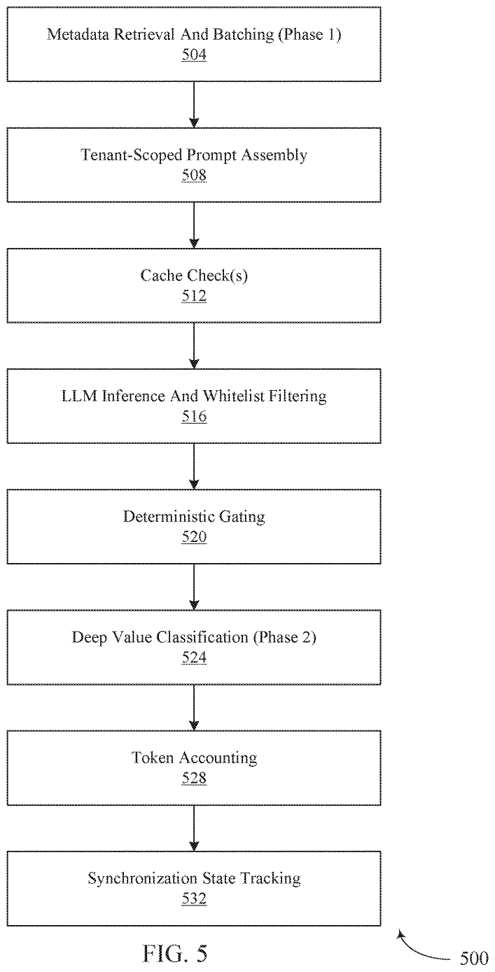

FIG. 5 is a flow diagram of a process 500 for data classification in multi-tenant cloud infrastructure, according to the present teachings. Although the process steps are described with reference to the systems and processes of FIGS. 1-4, persons skilled in the art will understand that any system adapted to implement the method steps, in any order, falls within the scope of the present invention. Operations of the process 500 can be performed by one or more components of the cloud infrastructure security service 132. For example, one or more operations of the process 500 may be performed by the data classification module 212 and/or the data lineage module 220 described with reference to FIG. 2.

In some examples, the process 500 is performed when the cloud infrastructure security service 132 initiates a data classification scan of custom data fields defined within one or more connected tenant organizations of the multi-tenant cloud platform 124, such as upon initial connection of a tenant organization, upon a scheduled classification refresh, or upon detection of new or modified custom fields within a tenant organization.

At step 504, the process 500 can include metadata retrieval and batching. For example, the data classification module 212 can retrieve field-metadata descriptors from the multi-tenant cloud platform 124 via the one or more cloud platform APIs 128, each field-metadata descriptor comprising information such as the field name, field data type, associated object or entity name, and any available description or help text. In some examples, the data classification module 212 can partition the retrieved field-metadata descriptors into size-bounded batches, each batch comprising a predetermined number of descriptors, such as five (5) descriptors per batch, for submission to one or more LLM agents 228 for metadata-level classification.

As an example, a tenant organization having one hundred (100) custom fields requiring metadata-level classification can produce twenty (20) inference batches under the five-field batch size, each batch carrying five field-metadata descriptors. Where the prompt template, per-tenant regulation vocabulary, and per-tenant keyword set together comprise approximately one thousand (1,000) prompt prefix tokens, the total prompt prefix token consumption across the twenty batches may be approximately twenty thousand (20,000) tokens, of which a substantial portion may be served from the Tier-2 provider-native prefix cache after the first batch.

At step 508, the process 500 can include tenant-scoped prompt assembly. For example, the data classification module 212 can retrieve, from a tenant-isolated configuration store, a per-tenant regulation vocabulary and a per-tenant keyword set associated with the tenant organization for which the classification scan is being performed. The data classification module 212 can inject the per-tenant regulation vocabulary and the per-tenant keyword set into a parameterized prompt template to assemble an inference prompt for each batch of field-metadata descriptors. As used herein, the term “per-tenant regulation vocabulary” may refer to a set of regulatory classification categories, such as GDPR, HIPAA, PCI-DSS, CCPA, and/or tenant-custom regulatory categories, that are applicable to the tenant organization and against which LLM-generated classification outputs may be validated.

At step 512, the process 500 can include performing one or more cache checks. For example, the data classification module 212 can compute a cryptographic digest of a canonical serialization of the assembled inference prompt, comprising the prompt template version identifier, a canonical digest of the per-tenant regulation vocabulary, a canonical digest of the per-tenant keyword set, and/or a canonical serialization of the input batch, and can query a Tier-1 application-layer content-addressable cache keyed on the computed digest. As used herein, the term “Tier-1 application-layer content-addressable cache” may refer to a cache persisted in a relational database and keyed on a cryptographic digest, such as a SHA-256 hash, of a canonical serialization of the inference prompt inputs, including the prompt template version identifier, the per-tenant regulation vocabulary digest, the per-tenant keyword set digest, and the input batch serialization, such that a cache hit may be detected when an identical combination of inputs has been previously submitted and the corresponding classification result has been stored.

In some examples, the canonical serialization of the input batch used by the data classification module 212 to compute the cryptographic digest may be lexicographically ordered to provide digest stability across semantically equivalent inputs, such that reordering of field-metadata descriptors within a batch does not produce a different digest when the descriptors are semantically identical.

In some examples, the canonical serialization of the input batch used by the data classification module 212 to compute the cryptographic digest may be implemented by sorting the field-metadata descriptors within the batch in lexicographic order on a stable composite sort key comprising at least the entity definition identifier and the field name, prior to serialization. The canonical serialization may be performed using a deterministic encoding that produces an identical byte sequence for a given set of field-metadata descriptors regardless of the input order in which the descriptors were retrieved from the multi-tenant cloud platform 124, such that semantically equivalent batches produce bit-identical cache keys.

In some examples, where a Tier-1 cache hit is detected, the data classification module 212 can return the stored classification result without any network transmission to a large language model inference endpoint, thereby eliminating both token cost and provider-side rate-limit consumption for that batch. In some examples, where a Tier-1 cache miss is detected, the data classification module 212 can proceed to large language model inference at step 516, with a Tier-2 provider-native prefix cache engaged on the Tier-1 miss. As used herein, the term “Tier-2 provider-native prefix cache” may refer to a caching mechanism provided by the large language model inference provider, such as a prefix caching feature that reuses previously computed key-value representations for shared prompt prefixes, and that is engaged only when the Tier-1 application-layer cache does not contain a stored result for the computed digest, such that the Tier-2 cache may reduce inference latency and token cost for requests that share common prompt prefixes without eliminating the network round-trip to the inference provider.

By way of illustration, a first batch comprising the field-metadata descriptors [Account.SSN, Account.Email] and a second batch comprising the same descriptors in the reversed order [Account.Email, Account.SSN] can represent semantically equivalent inputs to the metadata classification phase. Without canonical ordering, the two batches may produce distinct cryptographic digests and the second batch may miss the Tier-1 cache notwithstanding that an identical classification result has already been computed and stored. Under the canonical lexicographic ordering described herein, both batches can be sorted to the same canonical sequence [Account.Email, Account.SSN] prior to digest computation, thereby yielding a single bit-identical cache key and enabling the second batch to be served from the Tier-1 cache without network transmission to the language model inference endpoint.

At step 516, the process 500 can include LLM inference and whitelist filtering. For example, the data classification module 212 can submit each assembled inference prompt to an LLM inference endpoint via one or more LLM agents 228 to obtain classification outputs for the field-metadata descriptors in the batch. Responsive to receiving the LLM inference output, the data classification module 212 can apply a post-inference whitelist filter that discards any model-emitted classification category not present in the per-tenant regulation vocabulary, thereby suppressing hallucinated or out-of-vocabulary classification categories deterministically without model re-prompting.

As an example, the per-tenant regulation vocabulary for a given tenant organization may comprise the set {PII, GDPR, HIPAA, PCI, CCPA}. In such examples, a Phase-1 classification output for the candidate field Patient. MedicalRecordNumber may comprise the suggested categories {HIPAA, PII, HITECH}. The post-inference whitelist filter may retain the categories HIPAA and PII because each is present in the per-tenant regulation vocabulary, and may discard the category HITECH because it is not, without any re-prompting of the language model. The filtered result {HIPAA, PII} may be persisted as the Phase-1 classification result.

At step 520, the process 500 can include deterministic gating. For example, for each field classified in the metadata classification phase of step 516, the data classification module 212 can evaluate a tenant-configurable Boolean predicate over the Phase-1 classification output for the field, the field data type, and the per-tenant keyword set, to determine whether the field should be admitted to the deep-value classification phase of step 524. In some examples, the Boolean predicate may be evaluated in constant time per field without LLM inference, such that only fields for which the predicate returns a true value may proceed to deep-value classification, thereby bounding LLM inference cost to the cardinality of admitted fields rather than the total field cardinality.

In some examples, the tenant-configurable Boolean predicate evaluated by the data classification module 212 at step 520 may admit only fields of string or textarea data type to the deep-value classification phase of step 524, such that fields of other data types may be excluded from deep-value classification regardless of the Phase-1 classification output.

At step 524, the process 500 can include deep value classification. For example, for each field admitted by the deterministic gating of step 520, the data classification module 212 can retrieve a bounded sample of record-level values for that field from the data layer of the multi-tenant cloud platform 124 via the one or more cloud platform APIs 128, assemble and submit an LLM inference prompt distinct from the Phase-1 prompt to one or more LLM agents 228, and correlate the resulting classification output to the Phase-1 classification output via a composite key comprising at least a record identifier, an entity definition identifier, and a field name, producing a joined classification result that preserves both aggregated field-level classification and record-level evidence pointers.

At step 528, the process 500 can include token accounting. For example, the data classification module 212 can maintain per-tenant counters of input tokens, output tokens, cache-read tokens, and cache-write tokens consumed during the classification scan, such that per-tenant LLM inference cost may be attributed for chargeback and commercial billing purposes. In some examples, the token accounting subsystem may collect token metrics across both Tier-1 cache hits and Tier-1 cache misses, and may attribute shared overhead such as prompt prefix tokens to the appropriate tenant.

At step 532, the process 500 can include synchronization state tracking. For example, the data classification module 212 can maintain, for each classification result, a tri-valued synchronization state selected from a set comprising a synced state, a partially-synced state, and a not-synced state, representing the reconciliation status between the AI-suggested compliance classification and the native compliance metadata of the multi-tenant cloud platform 124. In some examples, the tri-valued synchronization state may be persisted in a relational schema supporting targeted partial remediation, such that only fields whose synchronization state indicates a discrepancy may be re-classified without requiring a full tenant rescan.

As an example, an AI-suggested compliance classification of {HIPAA, PII} for a field whose native compliance metadata in the multi-tenant cloud platform 124 already records {HIPAA, PII} produces a synchronization state of SYNCED. An AI-suggested classification of {HIPAA, PII} against a native classification of {HIPAA} (e.g., where the AI suggestion is a strict superset of the native value) may produce a synchronization state of PARTIALLY_SYNCED. An AI-suggested classification of {HIPAA, PII} against a native classification of {} (e.g., having no native compliance metadata) or {PCI} (e.g., having a disjoint native value) may produce a synchronization state of NOT_SYNCED.

The process 500 may enable cost-bounded, gated multi-phase classification of sensitive data fields across multi-tenant cloud infrastructure. By admitting only fields satisfying the deterministic gating predicate to deep-value classification, the process 500 may bound total LLM inference cost to the cardinality of admitted fields rather than the total field cardinality. By applying a post-inference whitelist filter against the per-tenant regulation vocabulary, the process 500 may suppress model-fabricated classification categories without model retraining or re-prompting. By keying the Tier-1 content-addressable cache on a cryptographic digest that incorporates tenant-specific vocabulary and keyword digests, the process 500 may prevent classification cache entries from being returned across tenant boundaries even in the event of prompt collision.

By way of example, in a tenant organization for which the default gating predicate is in effect, a candidate field with developer name Account. Email and data type string may produce a Phase-1 classification output suggesting categories {PII, GDPR} and may be admitted to Phase-2 deep-value classification because (i) at least one suggested category is present in the per-tenant regulation vocabulary, (ii) the field data type string is among the admissible data types, and (iii) the Phase-1 rationale matches at least one keyword in the per-tenant keyword set. In contrast, a candidate field with developer name Account. AnnualRevenue and data type currency can produce a Phase-1 classification output suggesting category {PCI} but may not be admitted to Phase-2, because the field data type currency is not among the admissible data types under the default predicate. A tenant organization that has uploaded an override predicate admitting the data types {string, textarea, currency} can, under the same Phase-1 output, admit the second field to Phase-2.

The two-phase classification approach with deterministic gating described herein can provide a specific technical improvement over approaches that apply LLM inference uniformly to all data fields in a tenant organization. In large multi-tenant cloud platforms, the number of custom data fields may be in the thousands or tens of thousands, and applying deep-value LLM inference to each field would result in inference costs that scale linearly with the total number of fields. The deterministic gating function structurally bounds the number of deep-value classification invocations by admitting to the deep-value phase only fields that satisfy a Boolean predicate evaluated without any language model invocation, such that inference costs scale with the number of fields passing the gate rather than with the total number of fields. Additionally, the post-inference whitelist filter deterministically suppresses any classification category not present in the per-tenant regulation vocabulary without requiring re-prompting, which reduces the total number of inference invocations needed to obtain well-formed outputs. Together, these mechanisms reduce the total computational cost of the classification pipeline and improve the reliability of its outputs by preventing hallucinated classification categories from propagating to downstream compliance records.

In some examples, the Tier-2 provider-native prefix cache interface used by the data classification module 212 may be provider-agnostic, such that switching from one large language model inference provider to an alternative provider does not invalidate Tier-1 cached results stored in the application-layer content-addressable cache.

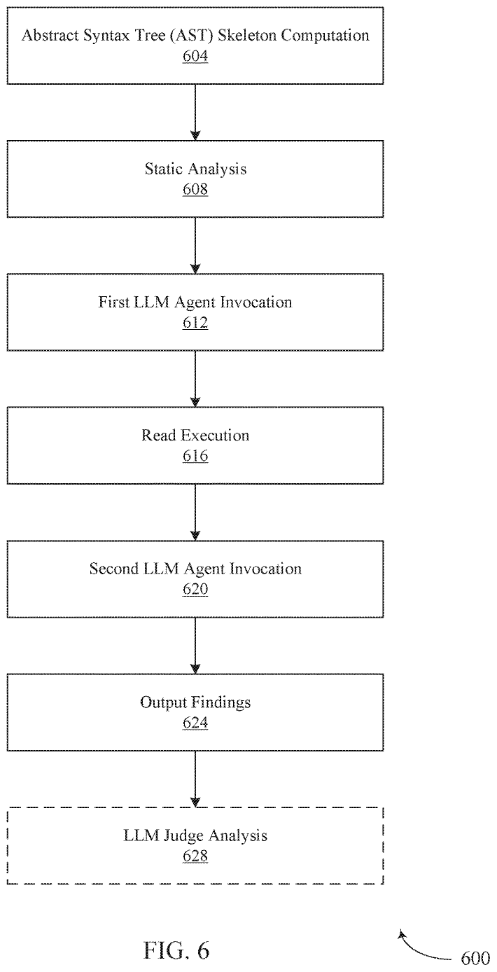

FIG. 6 is a flow diagram of a process 600 for source code analysis, according to the present teachings. Although the process steps are described with reference to the systems and processes of FIGS. 1-5, persons skilled in the art will understand that any system adapted to implement the method steps, in any order, falls within the scope of the present invention. Operations of the process 600 can be performed by one or more components of the cloud infrastructure security service 132. For example, one or more operations of the process 600 may be performed by the risk assessment module 224 described with reference to FIG. 2.

In some examples, the process 600 is performed when the cloud infrastructure security service 132 initiates a source code review of one or more source files associated with a connected tenant organization of the multi-tenant cloud platform 124, such as upon submission of a code change for deployment review or upon a scheduled security scan of the source code repository.

At step 604, the process 600 can include abstract syntax tree (AST) skeleton computation. For example, the risk assessment module 224 can deterministically compute, without invocation of a language model, an abstract syntax tree skeleton for each source file in a chunk of source files under review. As used herein, the term “abstract syntax tree skeleton” may refer to a structural representation of a source file comprising at least class identifiers, member signatures, annotations, and line ranges, and omitting member bodies, such that the skeleton may convey the structural organization of the source file without including the full source content.

At step 608, the process 600 can include static analysis. For example, the risk assessment module 224 can execute a deterministic static analyzer over the chunk of source files to produce a set of scanner hints, each scanner hint identifying a source file, a line or range within the source file, and a rule key corresponding to a potential security or quality issue detected by the static analyzer. In some examples, the static analysis of step 608 may be executed in parallel with the AST skeleton computation of step 604.

At step 612, the process 600 can include a first LLM invocation. For example, the risk assessment module 224 can perform a first invocation of one or more LLM agents 228 whose input consists of the AST skeletons computed at step 604, the scanner hints produced at step 608, and a language-specific scanner-contradiction catalogue enumerating known false-positive patterns of the static analyzer in natural language. In some examples, the first LLM invocation may emit as output only a plurality of targeted-read requests, each comprising a file identifier, an offset, and a limit, and may emit no findings, such that the first invocation may function as a triage pass that identifies which portions of the source files require closer examination.

In some examples, the language-specific scanner-contradiction catalogue provided to the one or more LLM agents 228 at step 612 may be selected from a set of profiles comprising at least profiles for Apex-language sharing declarations, Salesforce XML metadata, Node and TypeScript module resolution, Angular template variable declarations, Docker build artifacts, and/or a generic profile. Each profile may comprise a natural-language enumeration of known false-positive patterns specific to the corresponding language or framework. For example, an Apex-language profile may include an instruction to reject any missing-sharing hint when the class declaration contains a with sharing, without sharing, or inherited sharing annotation, and an Angular template profile may include an instruction to reject any undefined variable hint on a template variable declared via a let declaration.

The scanner-contradiction catalogue provided to the language model during the analysis steps described herein can address a specific technical problem in hybrid static-analysis and LLM pipelines. Static analyzers are known to produce false-positive findings for certain patterns that are valid or safe in a given programming language or framework context. Without a mechanism to identify and suppress such false positives, a hybrid pipeline that feeds static analyzer output to a language model may result in spurious findings that propagate to downstream enforcement actions, degrading the signal-to-noise ratio of security determinations. The scanner-contradiction catalogue, which enumerates known false-positive patterns of the static analyzer in natural language, provides the language model with the information needed to identify and omit scanner hints that are contradicted by the retrieved source windows, reducing the rate of false-positive findings in the pipeline's output. This represents a specific technical improvement to the quality of the security analysis pipeline's outputs.

By way of example, a candidate Apex source file containing a class declaration public with sharing class AccountController {public void updateAccount(Id accountId, String name) {/*fifty lines of body*/} public Account getAccount(Id accountId) {/*twenty lines of body*/}} may be reduced by the deterministic parser to a structural skeleton such as:

```
file: AccountController.cls
class: AccountController [public, with sharing] (lines 1-73)
  member: updateAccount(Id accountId, String name): void [public] (lines 4-55)
  member: getAccount(Id accountId): Account [public] (lines 57-72)
```

The skeleton can convey the structural organization of the source file (e.g., class identifier, member signatures, sharing annotation, and line ranges) while omitting the member bodies. In examples where the original source file contains seventy-three lines of source content, the corresponding skeleton may comprise fewer than ten lines of textual representation, providing an order-of-magnitude reduction in the token representation of the candidate source file presented to the first LLM invocation.

At step 616, the process 600 can include read execution. For example, the risk assessment module 224 can read, without invocation of any language model, the file ranges identified by the targeted-read requests emitted at step 612, producing a plurality of source windows comprising the actual source content at the requested offsets and limits. In some examples, the read execution of step 616 may be performed using a line-range file-read tool that accepts a file identifier, a starting line offset, and a line limit.

At step 620, the process 600 can include a second LLM invocation. For example, the risk assessment module 224 can perform a second invocation of one or more LLM agents 228 whose input consists of the AST skeletons computed at step 604, the source windows produced at step 616, the scanner hints produced at step 608, and the language-specific scanner-contradiction catalogue. In some examples, the second LLM invocation may emit as output a set of findings, wherein scanner hints contradicted by the source windows under the scanner-contradiction catalogue may be omitted from the findings. In some examples, conversation history from the first LLM invocation of step 612 may not be carried into the second LLM invocation, such that the total context presented to the language model per chunk may be bounded by the sum of skeleton size and source-window size and may be independent of the number of targeted-read requests.

In some examples, the process 600 may further comprise detecting a cross-file framework project by identifying a co-located triad of source files sharing a common component base name, such as a TypeScript file, an HTML file, and a CSS file associated with a single Angular component. Responsive to detection of such a triad, the risk assessment module 224 may dispatch a dedicated framework sub-agent, via the one or more LLM agents 228, over the identified triad in addition to any language-level sub-agents dispatched for individual source files. In some examples, the framework sub-agent may receive, in the input provided to the sub-agent, metadata identifying the members of each detected triad.

By way of example, a directory containing the source files AccountList.component ts, AccountList.component.html, and AccountList.component.css can represent a co-located triad sharing the common component base name AccountList. The co-located-triad detector can enumerate the sibling files within the directory, extract the common base name by removing the trailing extensions and the trailing.component decorator suffix, and identify the three files as a single Angular component triad. The risk assessment module 224 can dispatch a dedicated framework sub-agent over the triad, providing as input the structural skeletons of all three files together with metadata identifying the files as members of a co-located triad. The framework sub-agent may then identify cross-file issues (e.g., a template variable referenced in the HTML file that is not declared in the corresponding TypeScript class) that may not be otherwise detectable when analyzing any of the three files in isolation.

At step 624, the process 600 can include outputting or emitting read findings. For example, the risk assessment module 224 can emit the findings produced by the second LLM invocation of step 620 in a stable, machine-readable schema, each finding comprising at least a file identifier, a line or range, a rule key, and a description of the identified issue. In some examples, findings of severity below a configurable threshold may be aggregated into per-rule counts prior to the LLM judge analysis of step 628.

In some examples, the aggregation of findings of severity below the configurable threshold at step 624 may be accompanied by an instruction, provided in a system prompt to the one or more LLM agents 228 at step 628, prohibiting re-expansion of the aggregate per-rule counts into individual findings, such that the judge-model invocation may operate on the compressed aggregate representation without regenerating the individual low-severity findings.

At step 628, the process 600 can include LLM judge analysis of the findings. For example, the risk assessment module 224 can perform a judge-model invocation that consumes the aggregated outputs of one or more chunks processed through steps 604 through 624, and emits a normalized set of findings bounded by rules preserved across the serialization of the per-chunk outputs. In some examples, the judge-model invocation may occur in a second model tier of higher per-token cost than the model tier used for the first and second LLM invocations of steps 612 and 620, such that the higher-cost model may be applied only to the aggregated and compressed outputs rather than to the full source content.

The process 600 may enable bounded-context hybrid static-analyzer and language-model source code review with reduced token consumption relative to approaches that pass entire source files to a language model on each invocation. By separating the triage pass of step 612 from the review pass of step 620 and not carrying conversation history between the two invocations, the process 600 may bound the total context presented to the language model per chunk to the sum of skeleton size and source-window size, independent of the number of targeted-read requests. By injecting a language-specific scanner-contradiction catalogue into both LLM invocations, the process 600 may reduce the rate of false-positive findings arising from known false-positive patterns of the static analyzer.

In some examples, responsive to a transient failure of either the first LLM invocation of step 612 or the second LLM invocation of step 620, the risk assessment module 224 may restart the sub-agent pipeline for the affected chunk from step 604 without preserving any state from the failed invocation, up to a bounded retry count. By discarding all state from the failed invocation and restarting from the AST skeleton computation step, the process 600 may avoid propagating partial or corrupted intermediate results into subsequent analysis steps.

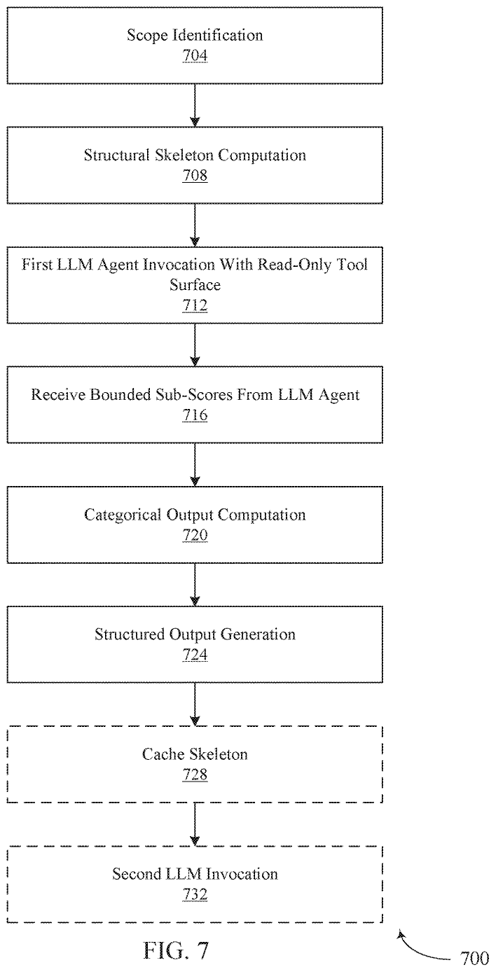

FIG. 7 is a flow diagram of a process 700 for orchestration of LLM agents over source code repositories, according to the present teachings. Although the process steps are described with reference to the systems and processes of FIGS. 1-6, persons skilled in the art will understand that any system adapted to implement the method steps, in any order, falls within the scope of the present invention. Operations of the process 700 can be performed by one or more components of the cloud infrastructure security service 132. For example, one or more operations of the process 700 may be performed by the risk assessment module 224 described with reference to FIG. 2.

In some examples, the process 700 is performed when the cloud infrastructure security service 132 initiates a bounded agentic retrieval analysis over a source code corpus associated with a connected tenant organization of the multi-tenant cloud platform 124, such as responsive to submission of a pull request, upon a scheduled security assessment, or upon detection of a configuration change that may implicate source code components.

At step 704, the process 700 can include scope identification. For example, the risk assessment module 224 can receive a user-specified scope identifying a plurality of candidate source files within a source code corpus, such as a repository subtree, a commit, a diff, a pull request, or an explicit file list. In some examples, the scope identification may be performed by selecting, from a registry of framework descriptors, a descriptor whose filename predicate matches each candidate source file, each descriptor comprising at least an identity, a filename predicate, a prompt builder, and optionally a source-content predicate.

In some examples, the registry of framework descriptors used at step 704 may be structured such that extending the process 700 to a new language or framework requires only addition of a new descriptor to the registry, with no modification to the structural skeleton computation of step 708, the LLM agent invocations of steps 712 and 732, or any other steps of the process 700. Each descriptor in the registry may comprise at least an identity, a filename predicate, a prompt builder, and optionally a source-content predicate, such that the registry may serve as a pluggable extension point for supporting additional languages and/or frameworks.

At step 708, the process 700 can include structural skeleton computation. For example, the risk assessment module 224 can pre-compute, by a deterministic parser and prior to any invocation of a language model, a structural skeleton for each candidate source file identified at step 704, the structural skeleton comprising at least class identifiers, member signatures, annotations, and line ranges, and omitting member bodies. In some examples, upon a second or subsequent reference to a source file already processed during the same analysis run, the risk assessment module 224 can serve the cached structural skeleton without re-invoking the parser.

At step 712, the process 700 can include a first LLM agent invocation with a read-only tool surface. For example, the risk assessment module 224 can invoke one or more LLM agents 228 with a tool surface consisting of a closed read-only set comprising at least a skeleton-retrieval tool returning a pre-computed skeleton from step 708, a line-range file-read tool accepting a file identifier, a starting line offset, and a line limit, a directory-listing tool, a filename-pattern tool, and a content-pattern tool, and excluding any tool capable of writing to a filesystem, modifying the source corpus, or spawning a sub-agent. In some examples, a system prompt associated with the first LLM agent invocation may require that the agent shall not emit a negative result for any candidate source file unless the agent has previously received, through the skeleton-retrieval tool, the skeleton of that file.

In some examples, the line-range file-read tool included in the closed read-only tool set provided to the one or more LLM agents 228 at step 712 may reject any invocation in which the starting line offset or the line limit is not a single plain integer, thereby preventing malformed or adversarial tool invocations from producing unbounded or undefined read operations.

The use of a closed, read-only tool surface enforced by a tool surface controller software component can provide a specific technical improvement to the security of agentic AI systems deployed in code analysis contexts. In systems where a language model agent can invoke arbitrary tools including write, execute, delete, or sub-agent-spawning operations, a hallucinating or adversarially influenced model poses a risk of modifying the source corpus, corrupting the analysis infrastructure, or acquiring expanded capabilities through sub-agent delegation. The techniques described herein address this specific technical risk by architecturally constraining the agent's available tool calls to a statically defined closed set of read-only functions. This constraint is enforced by the tool surface controller at the infrastructure level, independently of the language model's instructions or outputs, such that the agent cannot acquire write or execute capabilities regardless of the content of its tool call requests. This represents a specific technical improvement to how agentic AI systems are securely deployed, and is not merely the application of a generic AI agent framework to the cybersecurity domain.

By way of example, the language model may emit a tool invocation request {tool: “read_file”, arguments: {fileId: “AccountController.cls”, startLine: “5”, lineLimit: “20”}}. In such an example, the tool-surface-controller component can validate that (i) the tool identifier read_file is present in the static registry of permitted tool identifiers, and (ii) the numeric arguments are single plain integers. Because the arguments startLine and lineLimit are encoded as quoted strings rather than plain integers, the tool-surface-controller may reject the invocation and emit a structured rejection record {rejected: true, reason: “non-integer numeric argument”, tool: “read_file”}. In contrast, a request {tool: “read_file”, arguments: {fileId: “AccountController.cls”, startLine: 5, lineLimit: 20}} can be admitted and dispatched to the line-range file-read tool. A request {tool: “write_file”, arguments: { . . . }} can be rejected on the basis that write_file is not present in the static registry, regardless of the validity of its arguments.

At step 716, the process 700 can include receiving bounded sub-scores from the invoked LLM agent. For example, the risk assessment module 224 can receive, from one or more LLM agents 228, for each identified member of a candidate source file, a plurality of numeric sub-scores bounded to a fixed integer interval and summing to a fixed maximum. In some examples, a subset of scoring dimensions whose output may be deterministically computable by a static rule engine from the source of a candidate member may be identified prior to invocation of the language model and excluded from the system prompt, such that the probabilistic channel of the language model may be confined to dimensions that cannot be deterministically computed.

At step 720, the process 700 can include categorical output computation. For example, the risk assessment module 224 can compute a categorical output by applying a pure step function to a sum of the numeric sub-scores received at step 716, the categorical output being bit-identical across invocations of the step function with identical numeric input. As used herein, the term “pure step function” may refer to a deterministic function that maps a numeric input to a categorical output without side effects, such that the same numeric input may always produce the same categorical output regardless of the invocation context.

At step 724, the process 700 can include structured output generation. For example, the risk assessment module 224 can emit a structured output comprising, for each identified member of a candidate source file, the sum of the numeric sub-scores, the categorical output computed at step 720, and optionally an abstract-syntax-tree-derived behavioral-reach label drawn from a closed ordered set, the structured output being reproducible by a rule-based policy engine. In some examples, the structured output may be serialized to a token-optimized textual notation having a character count smaller than a JavaScript Object Notation serialization of the same structured output, for use as input to a subsequent language model stage.

As an example, where the structured output record comprises four dimension-specific sub-scores each bounded to the closed integer interval [0, 10], the sum of sub-scores can fall within the closed integer interval [0, 40]. The static lookup table can partition the sum domain into three contiguous, non-overlapping sub-ranges: [0, 15]→PASS, [16, 25]→WARN, [26, 40]→FAIL. Each sub-range may map to one categorical label, thereby enabling the categorical output to be uniquely determined for any admissible numeric input,.

As an example, a set of three findings serialized in JavaScript Object Notation may comprise approximately two hundred characters per finding, including field labels, brackets, and quoting. The same three findings serialized in the comma-separated-values notation having the documented column contract file, line, severity, rule, category, reason, recommendation may comprise approximately one hundred and twenty characters per finding, representing a reduction of approximately forty percent in character count and a corresponding reduction in input token count for the second language-model stage.

At step 728, the process 700 can include skeleton caching. For example, the risk assessment module 224 can cache the structural skeleton computed at step 708 for each candidate source file, such that upon a second or subsequent reference to a source file already retrieved by the skeleton-retrieval tool during the same analysis run, the cached structural skeleton may be served without re-invoking the deterministic parser. In some examples, skeleton caching may reduce redundant parser invocations when multiple analysis passes reference the same source files.

At step 732, the process 700 can include a second LLM invocation. For example, the risk assessment module 224 can invoke a second language model stage with the serialized structured output of step 724 as input, the second stage emitting a normalized output bounded by rules preserved across the serialization. In some examples, the second LLM invocation may occur in a model tier of higher per-token cost than the model tier used for the first LLM agent invocation of step 712, such that the higher-cost model may be applied only to the compressed and structured outputs rather than to the full source content or skeleton representations.

The process 700 may enable bounded agentic retrieval over source code repositories with reduced per-analysis input-token consumption relative to approaches that pass entire source files to a language model. By pre-computing deterministic structural skeletons and using the skeletons to focus subsequent retrieval, the process 700 may bound input-token consumption to the portions of source content strictly required for analysis. By constraining the LLM agent to a closed read-only tool surface and requiring skeleton retrieval before a negative result may be emitted for any candidate source file, the process 700 may cap agentic tool fan-out and reduce the rate of false-negative retrieval. By confining probabilistic LLM output to bounded numeric sub-scores that are transformed by a pure step function into categorical labels, the process 700 may produce structured outputs that are reproducible by rule-based policy engines across invocations with identical input.

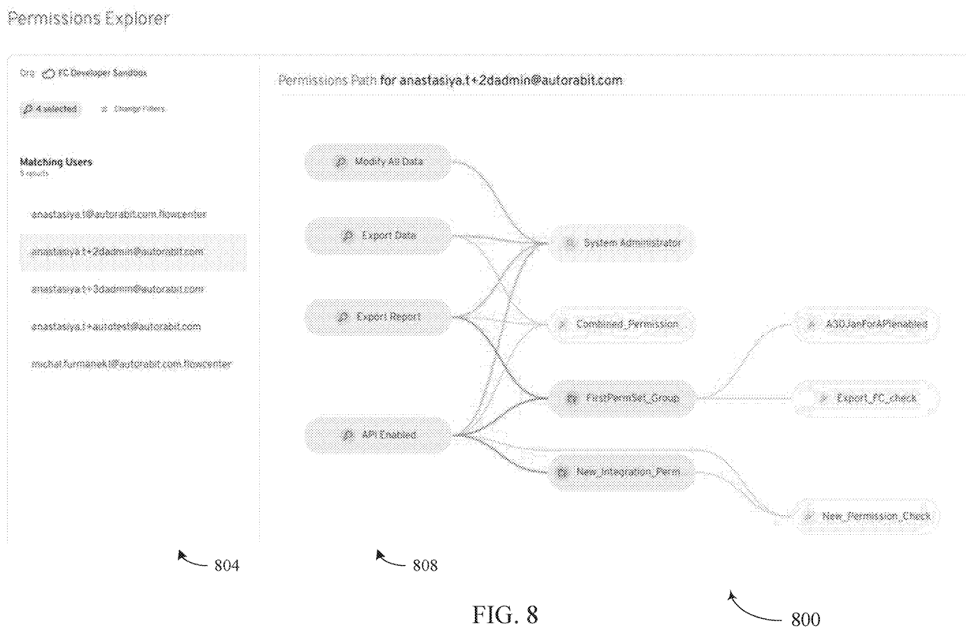

FIG. 8 illustrates an example permissions explorer graphical user interface (GUI) 800 that may be generated by the system computing device 104, according to the present teachings. For example, the permissions explorer GUI 800 may be generated by one or more components of the cloud infrastructure security service 132 and rendered to a display, such as a display of the client computing device 116.

In some examples, the permissions explorer GUI 800 may categorize the permissions available for analysis into familiar IT security categories, such as access control, custom code, data export, data import, integration, and/or the like. The categorization may bridge the gap between the permission terminology specific to the multi-tenant cloud platform 124 and traditional IT security practices, enabling security professionals to evaluate platform-specific permissions in the context of the security policies of the organization of the security professional. For example, a permission such as an Author Apex permission, which grants a user the ability to access all Apex classes in the associated tenant organization regardless of the security settings for individual classes, may be categorized under a custom code security category rather than being presented using the platform-specific terminology alone.

The permissions explorer GUI 800 may include a filtering panel 804 and a permissions path visualization panel 808. The filtering panel 804 may display a selected tenant organization, such as a Salesforce org identified by name, and may indicate the number of permissions currently selected for analysis, such as four (4) selected permissions. The filtering panel 804 may include a change filters control that enables a user to modify the selected permissions or add additional filtering criteria, such as excluding users who hold a particular profile assignment.

In some examples, the filtering panel 804 may display a list of matching users identified as holding all of the selected permissions within the specified tenant organization, together with a count of the total number of matching results. Each matching user may be identified by a username or email address within the list. Responsive to selection of a user from the matching users list, the permissions path visualization panel may display a permissions path for the selected user. As used herein, the term “permissions path” may refer to a hierarchical representation of the chain of security controls, including profiles, permission sets, and permission set groups, through which a particular permission is granted to a particular user.

The permissions path visualization panel 808 may render the permissions path as a tree structure in which each node represents a permission, a profile, a permission set, or a permission set group, and edges between nodes represent assignment or membership relationships. For example, the permissions path for a selected user may display permissions such as Modify All Data, Export Data, Export Report, and API Enabled as leaf nodes, and may display the profile or permission set through which each permission is granted as a parent node. In some examples, a permission may be granted through a permission set group, which may in turn contain one or more permission sets, such that the permissions path may include multiple levels of intermediate nodes between the user and the underlying permission. The permissions path visualization panel may enable a user to trace the complete chain of security controls responsible for granting a given permission to a given user, supporting identification of over-privileged access and enabling targeted remediation actions.

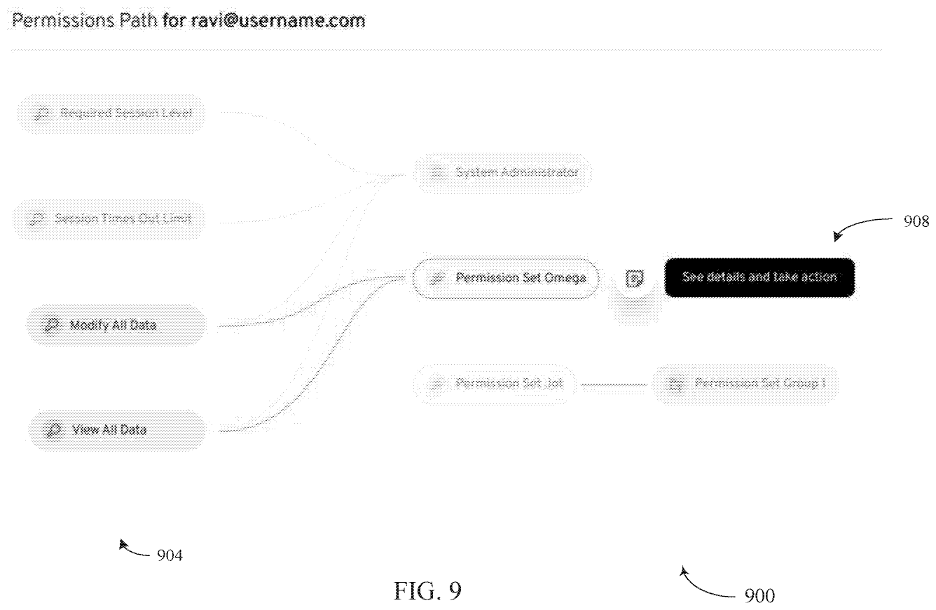

FIG. 9 illustrates an example permissions explorer GUI 900 that may be generated by the system computing device 104, according to the present teachings. For example, the permissions explorer GUI 900 may be generated by one or more components of the cloud infrastructure security service 132 and rendered to a display, such as a display of the client computing device 116.

The permissions explorer GUI 900 may display a permissions path 904 for a selected user, such as a user identified by a username or email address. The permissions path 904 may be rendered as a tree structure in which each node represents a permission, a profile, a permission set, or a permission set group, and edges between nodes represent assignment or membership relationships. For example, the permissions path 904 for a selected user may include a Required Session Level node connected to a System Administrator profile node, a Session Times Out Limit node connected to a Permission Set Omega node, a Modify All Data permission node connected to a Permission Set Jot node, and a View All Data permission node connected to a Permission Set Group 1 node, reflecting the multiple paths through which the selected user has been granted access to sensitive permissions.

In some examples, the permissions explorer GUI 900 may enable a user to select a particular node within the permissions path tree to view additional details associated with that node and to initiate remediation actions. For example, responsive to selection of the Permission Set Omega node, the permissions explorer GUI 900 may display a details selector 908 comprising a contextual action prompt, such as a “See details and take action” control, that enables the user to view detailed information about the selected permission set and to initiate the creation of a governance policy based on the selected node. In some examples, the details selector 908 may be rendered as an overlay or popover adjacent to the selected node within the permissions path tree, enabling the user to access node-level details without navigating away from the permissions path visualization.

By way of example, a selected user jdoe@example. com who has been granted the Modify All Data permission within a tenant organization may have a permissions path rendered as a tree such as:

```
User: jdoe@example.com
  |_{——} Permission Set Group: Administrative_Toolkit
    |_{——} Permission Set: System_Admin_Powers
      ├- Permission: Modify All Data
      ├- Permission: View All Data
      |_{——} Permission: Export Reports
  |_{——} Profile: Standard_System_Administrator
    |_{——} Permission: API Enabled
```

The permissions path tree can indicate that Modify All Data has been granted to the user via the chain User→Permission Set Group “Administrative_Toolkit”→Permission Set “System_Admin_Powers”→Permission “Modify All Data”, supporting identification of the specific node in the chain at which the grant could be revoked, while a separate independent chain User→Profile “Standard_System_Administrator”→Permission “API Enabled” can indicate that the user holds the API Enabled permission via a profile assignment rather than via the permission set group.

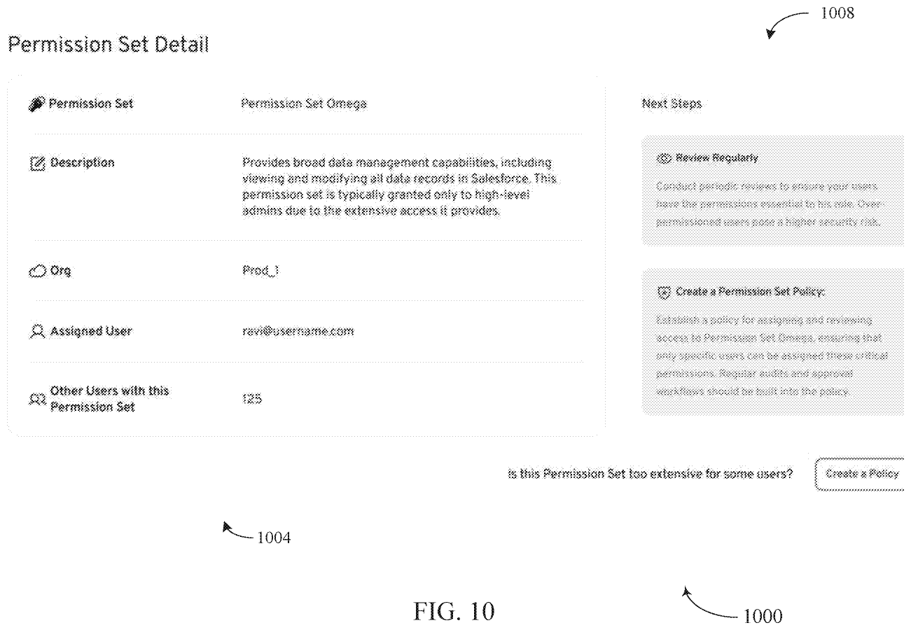

FIG. 10 illustrates an example permissions explorer GUI 1000 that may be generated by the system computing device 104, according to the present teachings. For example, the permissions explorer GUI 1000 may be generated by one or more components of the cloud infrastructure security service 132 and rendered to a display, such as a display of the client computing device 116.

The permissions explorer GUI 1000 may display a permission set detail panel 1004 for a permission set selected by a user within the permissions path visualization of the permissions explorer GUI 900. The permission set detail panel 1004 may present structured metadata associated with the selected permission set in a tabular format. For example, the permission set detail panel 1004 may display the name of the permission set, a description of the capabilities conferred by the permission set, the tenant organization in which the permission set is defined, the username of the user to whom the permission set is currently assigned, and the total number of other users within the tenant organization who hold the same permission set assignment.

In some examples, the description field may provide a plain-language explanation of the access rights conferred by the permission set, such as an indication that the permission set provides broad data management capabilities including the ability to view and modify all data records within the tenant organization, and that the permission set is typically granted only to users with elevated administrative responsibilities.

The permissions explorer GUI 1000 may display a next steps panel 1008 that presents recommended governance actions based on the selected permission set. For example, the next steps panel 1008 may include a recommendation to conduct periodic reviews of the users assigned to the permission set, with an explanation that over-permissioned users may pose an elevated security risk. The next steps panel 1008 may also include a recommendation to establish a governance policy for the selected permission set, with an explanation that a policy may enable the authoring user to restrict assignment of the permission set to a defined set of authorized users and to incorporate regular audits and approval workflows into the assignment process. In some examples, the next steps panel 1008 may include a prompt indicating whether the selected permission set may be too extensive for some of the users to whom it is currently assigned, and may present a create policy control that, when activated, initiates the policy creation workflow within the policy management module 204 to generate a new governance policy governing assignment of the selected permission set.

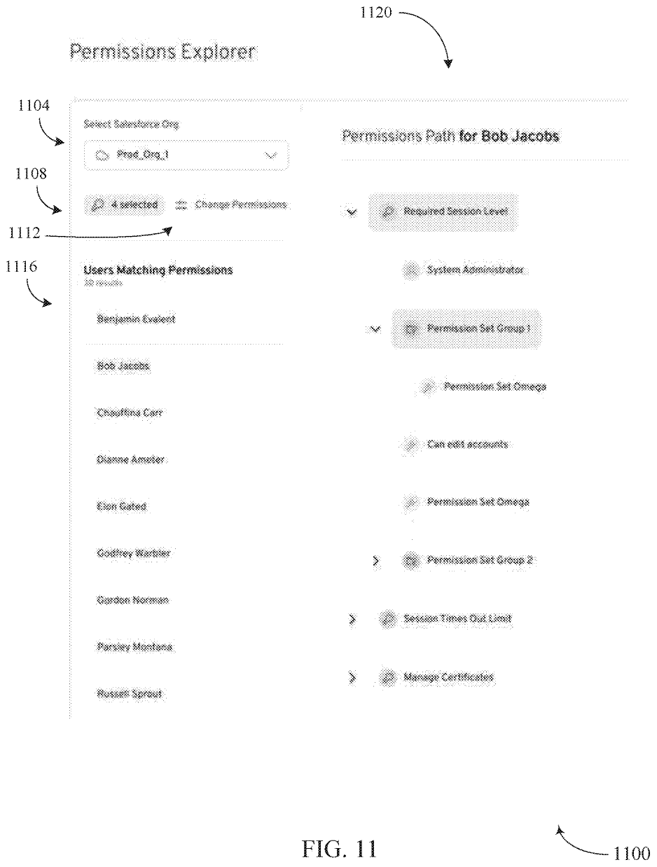

FIG. 11 illustrates an example permissions explorer GUI 1100 that may be generated by the system computing device 104, according to the present teachings. For example, the permissions explorer GUI 1100 may be generated by one or more components of the cloud infrastructure security service 132 and rendered to a display, such as a display of the client computing device 116.

The permissions explorer GUI 1100 may display an alternative view of the permissions path information presented in the permissions explorer GUI 800, rendered in a format that presents both the matching users list and the permissions path for a selected user in a side-by-side layout. The permissions explorer GUI 1100 may include an org selector control 1104 that enables a user to select a tenant organization for analysis, a permissions selector control 1108 indicating the number of permissions currently selected for analysis, and a change permissions control 1112 that enables the user to modify the selected permissions.

In some examples, the permissions explorer GUI 1100 may display a users matching permissions panel 1116 that lists the names of all users within the selected tenant organization who hold the selected permissions, together with a count of the total number of matching results. Responsive to selection of a user from the users matching permissions panel, the permissions explorer GUI 1100 may display a permissions path panel 1120 for the selected user. The permissions path panel 1120 may present the permissions path as a structured list or tree in which each entry represents a node in the chain of security controls through which the selected user has been granted the selected permissions. For example, the permissions path for a selected user may include a Required Session Level entry associated with a System Administrator profile, a Permission Set Group 1 entry containing a Permission Set Omega assignment and a Can edit accounts permission, a Permission Set Group 2 entry, a Session Times Out Limit entry, and a Manage Certificates permission entry, reflecting the multiple security controls through which the selected user has been granted access to the selected permissions.

In some examples, each entry in the permissions path panel 1120 may include an expand control that enables the user to view additional details associated with that entry, such as the specific permissions conferred by a permission set or the members of a permission set group. The permissions explorer GUI 1100 may enable a user to navigate the permissions path in a structured list format as an alternative to the tree visualization provided by the permissions explorer GUI 800.

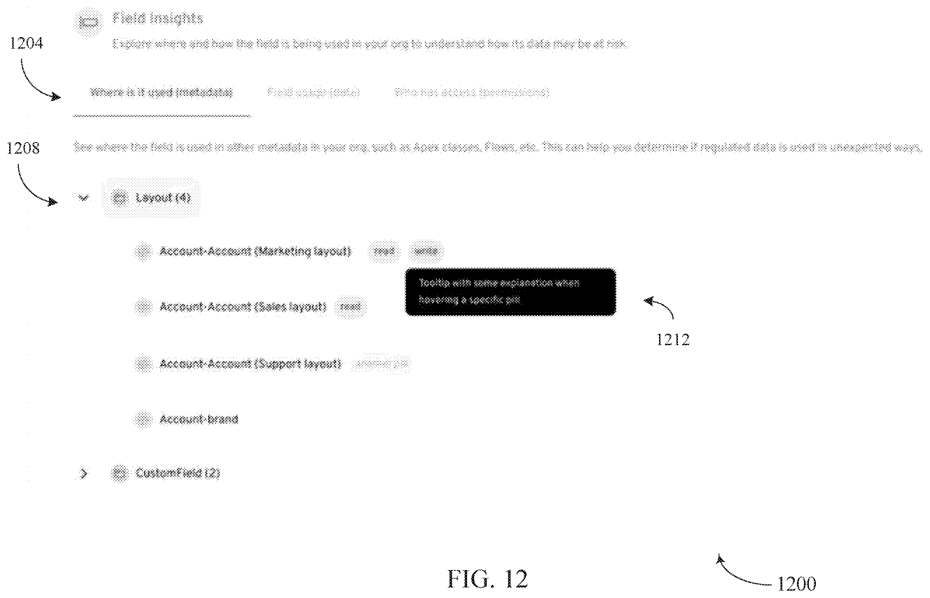

FIG. 12 illustrates an example data lineage GUI 1200 that may be generated by the system computing device 104, according to the present teachings. For example, the data lineage GUI 1200 may be generated by one or more components of the cloud infrastructure security service 132 (e.g., the data lineage module 220) and rendered to a display, such as a display of the client computing device 116.

The data lineage GUI 1200 may display field insight information for a selected sensitive data field within a connected tenant organization of the multi-tenant cloud platform 124. The data lineage GUI 1200 may include a tabbed navigation panel 1204 comprising a “Where is it used (metadata)” tab, a “Field usage (data)” tab, and/or a “Who has access (permissions)” tab, enabling a user to navigate between different categories of field insight information. In some examples, the data lineage GUI 1200 may display the “Where is it used (metadata)” tab as the active view, presenting information about the Salesforce metadata components that reference the selected field.

A metadata usage panel 1208 of the data lineage GUI 1200 may display a categorized list of metadata components that reference the selected field, organized by metadata type. For example, the metadata usage panel 1208 may display a Layout category comprising a count of page layouts that reference the selected field, such as four (4) layouts, and may expand to list each individual layout by name, such as Account-Account (Marketing layout), Account-Account (Sales layout), Account-Account (Support layout), and Account-brand. In some examples, each layout entry may include one or more access type indicators, such as read and write indicators, that identify the type of access the layout provides to the selected field. In some examples, a tooltip may be displayed upon interaction with an access type indicator to provide additional explanation of the access type.

The metadata usage panel 1208 may display a CustomField category comprising a count of custom fields that reference the selected field. In some examples, the metadata usage panel may include an expand control 1212 for each metadata type category that enables the user to view the complete list of metadata components within that category. The data lineage GUI 1200 may enable a user to determine whether a sensitive data field is referenced by metadata components in unexpected or unintended ways, supporting identification of potential data exposure risks.

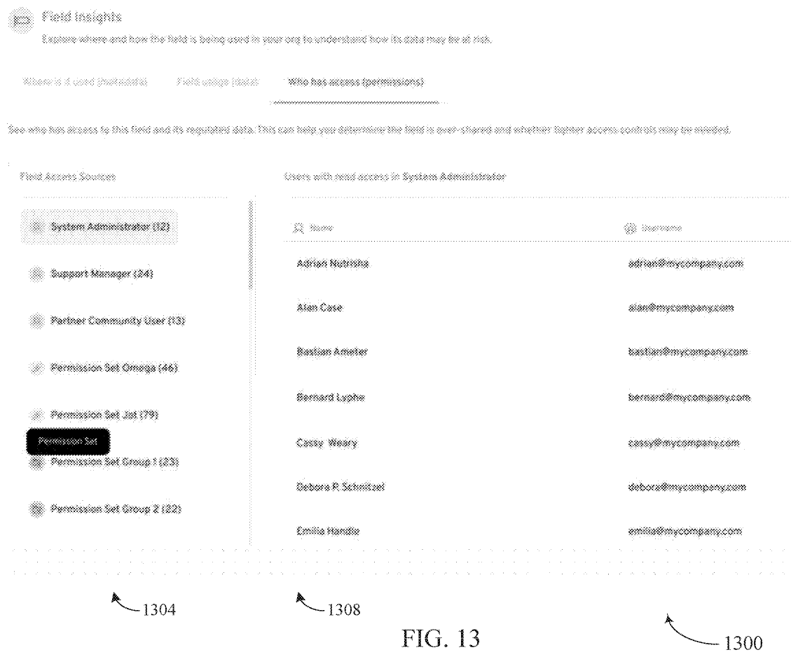

FIG. 13 illustrates an example data lineage GUI 1300 that may be generated by the system computing device 104, according to the present teachings. For example, the data lineage GUI 1300 may be generated by one or more components of the cloud infrastructure security service 132 (e.g., the data lineage module 220) and rendered to a display, such as a display of the client computing device 116.

The data lineage GUI 1300 may display field insight information for a selected sensitive data field within a connected tenant organization of the multi-tenant cloud platform 124, with the “Who has access (permissions)” tab active. The data lineage GUI 1300 may include a field access sources panel 1304 that presents a categorized summary of the profiles, permission sets, and permission set groups through which users within the tenant organization have been granted read access to the selected field. For example, the field access sources panel 1304 may display a list of access sources, each identified by name and accompanied by a count of the number of users who hold that access source, such as System Administrator (12 users), Support Manager (24 users), Partner Community User (13 users), Permission Set Omega (46 users), Permission Set Jot (79 users), Permission Set Group 1 (23 users), and Permission Set Group 2 (22 users). In some examples, a user may select an access source from the field access sources panel to filter the user list displayed in the data lineage GUI 1300 to show only the users who hold that particular access source.

The data lineage GUI 1300 may display a user list panel 1308 that presents the names and usernames of the individual users within the tenant organization who have been granted read access to the selected field through the selected access source. For example, the user list panel 1308 may display a table comprising a name column and a username column, with each row identifying a user by display name and by the username or email address associated with the user account within the tenant organization. The data lineage GUI 1300 may enable a user to determine which individuals within the tenant organization have access to a sensitive data field and through which security controls that access has been granted, supporting identification of over-shared fields and enabling targeted access control remediation.

In some examples, the data lineage GUI 1300 may interact with the policy management module 204 to enable the authoring user to initiate the creation of a governance policy directly from the field access findings displayed within the data lineage GUI 1300, such that access control policies may be generated based on the identified field access sources without requiring the user to navigate to a separate policy creation workflow.

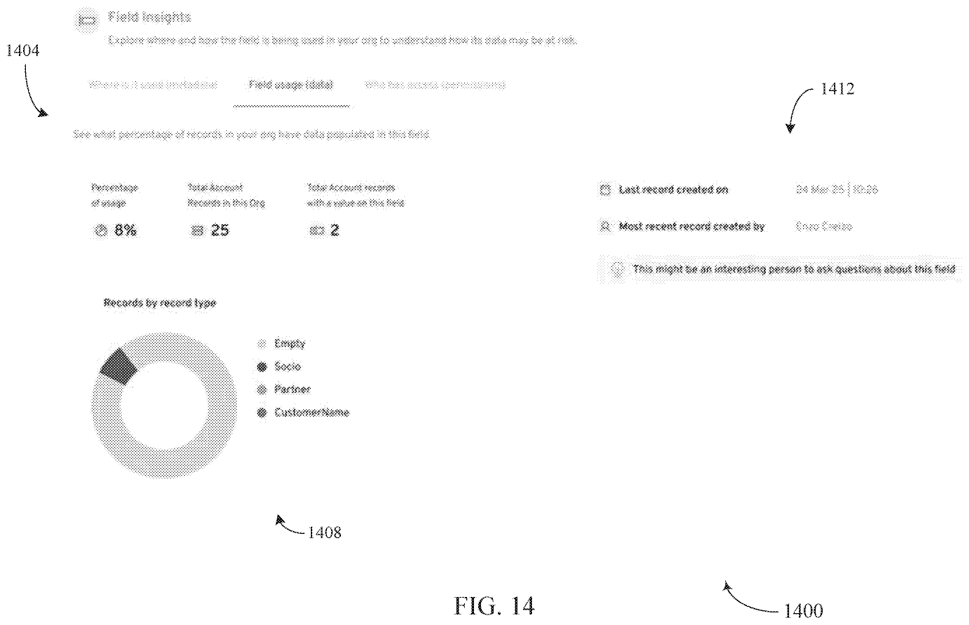

FIG. 14 illustrates an example data lineage GUI 1400 that may be generated by the system computing device 104, according to the present teachings. For example, the data lineage GUI 1400 may be generated by one or more components of the cloud infrastructure security service 132 (e.g., the data lineage module 220) and rendered to a display, such as a display of the client computing device 116.

The data lineage GUI 1400 may display field insight information for a selected sensitive data field within a connected tenant organization of the multi-tenant cloud platform 124, with the “Field usage (data)” tab active. The data lineage GUI 1400 may include a field usage metrics panel 1404 that presents quantitative information about the extent to which the selected field is populated with data across the records of the tenant organization. For example, the field usage metrics panel 1404 may display a percentage of usage metric indicating the proportion of records within the tenant organization that contain a non-null value in the selected field, such as eight percent (8%). The field usage metrics panel 1404 may display a total account records metric indicating the total number of records of the relevant object type within the tenant organization, such as twenty-five (25) records, and a total records with a value metric indicating the number of those records that contain a non-null value in the selected field, such as two (2) records.

By way of example, a field usage metric for the field Account. PatientApprovalStatus__c within a tenant organization containing twenty-five (25) records of the Account object may indicate that two (2) of the records contain a non-null value in the field, yielding a percentage of usage metric of 2/25=8%. The records-by-record-type breakdown may further indicate that the two records with a non-null value are of record types Customer and Partner, while no records of record type Internal contain a value in the field. The provenance metadata associated with the most recent of the two records may indicate a creation timestamp of 2026-01-15T14:23:00Z and a creating user mhealthcare@example.com, supporting identification of a potentially relevant contact for additional context regarding the field.

The data lineage GUI 1400 may display a records by record type panel 1408 that presents a breakdown of the records containing a value in the selected field, organized by record type. For example, the records by record type panel 1408 may display a chart or list identifying the record types present among the records with a value in the selected field, such as Empty, Socio, Partner, and CustomerName record types.

In some examples, the data lineage GUI 1400 may display additional provenance metadata 1412 associated with the selected field, such as the date and time at which the most recent record containing a value in the selected field was created, and the display name of the user who created that record. In some examples, the data lineage GUI 1400 may include a contextual note identifying the most recent record creator as a potentially relevant contact for obtaining additional information about the selected field and the data it contains. The data lineage GUI 1400 may enable a user to assess the extent to which a sensitive data field is actively used within the tenant organization, supporting risk assessment and data governance decisions.

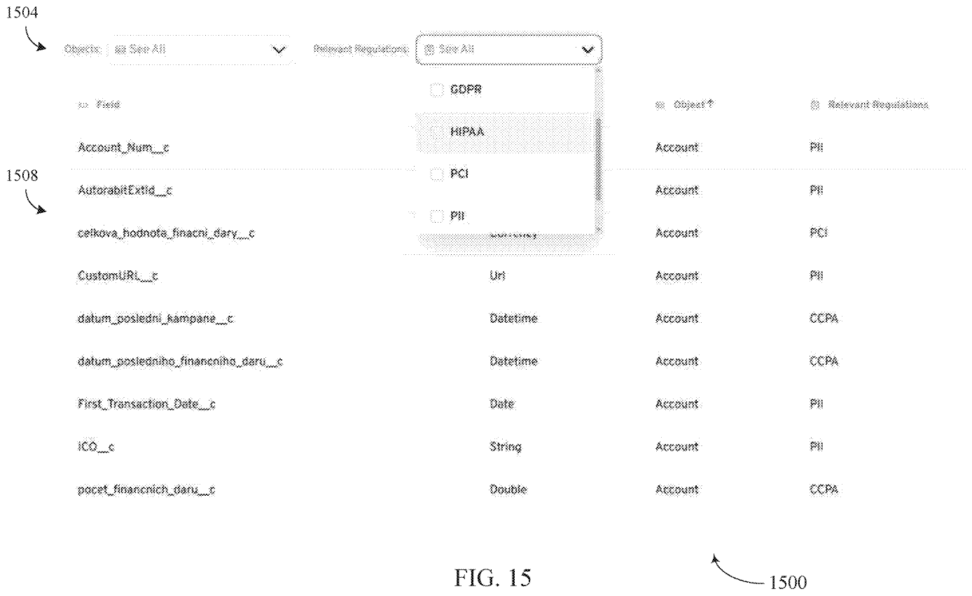

FIG. 15 illustrates an example data classification GUI 1500 that may be generated by the system computing device 104, according to the present teachings. For example, the data classification GUI 1500 may be generated by one or more components of the cloud infrastructure security service 132 (e.g., the data classification module 212) and rendered to a display, such as a display of the client computing device 116.

The data classification GUI 1500 may display the results of a data classification scan performed by the data classification module 212 across the custom fields of a connected tenant organization of the multi-tenant cloud platform 124. The data classification GUI 1500 may include a filter panel 1504 and a classification results panel 1508. The filter panel 1504 may include an objects filter control that enables a user to filter the displayed classification results by the Salesforce object with which each field is associated, and a relevant regulations filter control that enables the user to filter the displayed classification results by the regulatory classification category assigned to each field, such as GDPR, HIPAA, PCI, CCPA, and/or PII. In some examples, the filter panel may display the currently active filter selections and may provide a see all control that enables the user to view all available filter options.

The classification results panel 1508 may display a table of custom fields identified by the data classification scan as containing or potentially containing sensitive data, together with the regulatory classification category recommended for each field. For example, the classification results table may include a field name column identifying each custom field by its API name, an object column identifying the Salesforce object with which each field is associated, and a relevant regulations column identifying the regulatory classification category recommended for each field by the data classification module 212. In some examples, the data classification GUI 1500 may enable a user to review the recommended classifications, accept or modify individual classifications, and initiate auto-remediation to apply the accepted classifications directly to the corresponding fields within the multi-tenant cloud platform 124 via the one or more cloud platform APIs 128.

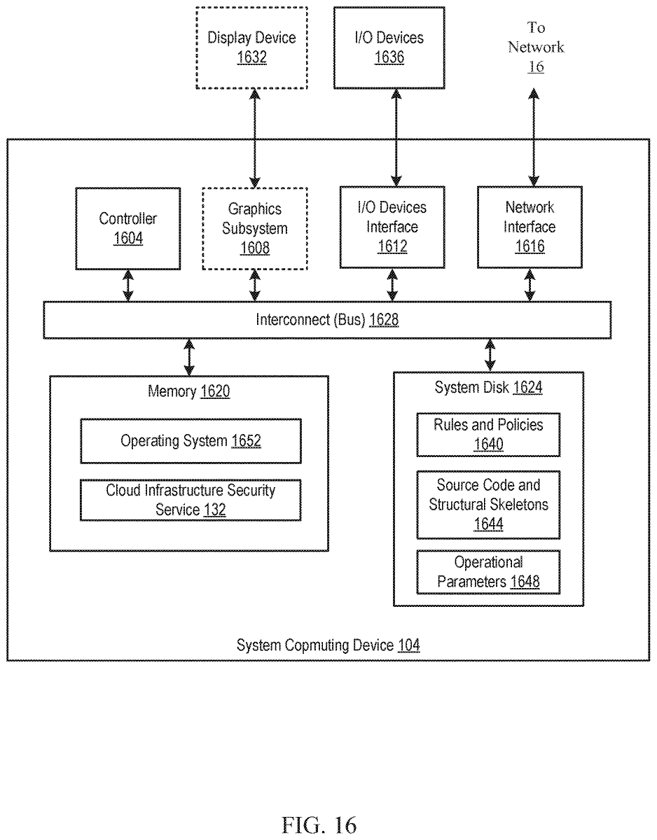

FIG. 16 is a block diagram of a system computing device 104 that may be implemented in conjunction with the computing system 100 of FIG. 1, according to present teachings. As shown in FIG. 16, the system computing device 104 can include, without limitation, at least one processor 1604, a graphics subsystem 1608, an input/output (I/O) devices interface 1612, a network interface 1616, a system memory 1620, a system disk 1624, and an interconnect 1628. The interconnect, or bus, 1628 can include one or more wires, cables, traces, contacts, analog components, digital components, wireless connection components, and/or other suitable means for interconnecting hardware components of the system computing device 104.

The processor 1604 is adapted to retrieve and execute programming instructions, such as a cloud infrastructure security service 132, stored in the system memory 1620. Similarly, the processor 1604 is adapted to store application data (e.g., software libraries) and retrieve application data from the memory 1620. The interconnect 1628 is adapted to facilitate transmission of data, such as programming instructions and application data, between the processor 1604, the graphics subsystem 1608, the I/O devices interface 1612, the network interface 1616, the system memory 1620, and the system disk 1624.

In some embodiments, the graphics subsystem 1608 is adapted to generate one or more graphical user interfaces associated with the cloud infrastructure security service 132 and transmit the GUIs to display device 1632. In some embodiments, the graphics subsystem 1608 is adapted to generate one or more frames of image and/or video data and transmit the frames of image and/or video data to display device 1632. In some embodiments, the graphics subsystem 1608 may be integrated into an integrated circuit, along with the processor 1604. The display device 1632 may comprise any technically feasible means for generating an image for display. For example, the display device 1632 may be fabricated using liquid crystal display (LCD) technology, cathode-ray technology, and light-emitting diode (LED) display technology. The display device 1632 may include, for example, one or more monitors.

The I/O devices interface 1612 is adapted to receive input data from I/O devices 1636 and transmit the input data to the processor 1604 via the interconnect 1628. For example, I/O devices 1636 may include one or more buttons, a keyboard, a mouse, and/or other input devices. The I/O devices interface 1612 is further adapted to receive output data from the processor 1604 via the interconnect 1628 and transmit the output data to the I/O devices 1636.

The system disk 1624 may include one or more hard disk drives, solid state storage devices, or similar storage devices. The system disk 1624 is configured to store non-volatile data such as files (e.g., audio files, video files, subtitles, application files, software libraries, etc.). As shown in FIG. 16, the system disk 1624 can be further configured to store rules and policies 1640 associated with security governance policies, validation rules, deviation findings, and policy enforcement configurations managed by the policy management module 204 and the change monitoring module 208; source code and structural skeletons 1644 associated with source code files retrieved from connected tenant organizations of the multi-tenant cloud platform 124 and pre-computed abstract syntax tree structural skeletons generated by the risk assessment module 224 for use in bounded agentic source code analysis; and/or operational parameters 1648 associated with learned chunk size values, staleness thresholds, configured floor values, and other adaptive request-size learning parameters maintained by the cloud infrastructure security service 132 for executing batched requests against the one or more cloud platform APIs 128.

The system memory 1620 can include programming instructions and application data that comprise an operating system 1652 and the cloud infrastructure security service 132. The processor 1604 can implement the cloud infrastructure security service 132 to receive natural-language policy intent from an authoring user and compile the policy intent into machine-enforceable configuration-validation rules using one or more large language model agents 228; apply the compiled validation rules against configuration metadata of one or more connected tenant organizations of the multi-tenant cloud platform 124 and record deviation findings when rule violations are detected; monitor configuration changes within connected tenant organizations by retrieving and enriching audit trail records from the multi-tenant cloud platform 124 via the one or more cloud platform APIs 128; classify sensitive data fields within connected tenant organizations using a two-phase large language model inference pipeline constrained by tenant-scoped regulatory vocabularies and a deterministic gating function; analyze data lineage and user access structures for sensitive data fields to identify which users and metadata components have access to classified fields; assess the security posture of connected tenant organizations by comparing current security settings against a predefined baseline and generating compliance scores and remediation recommendations; and perform source code analysis using bounded-context hybrid static-analyzer and large language model pipelines to identify security and quality issues in source code associated with connected tenant organizations.

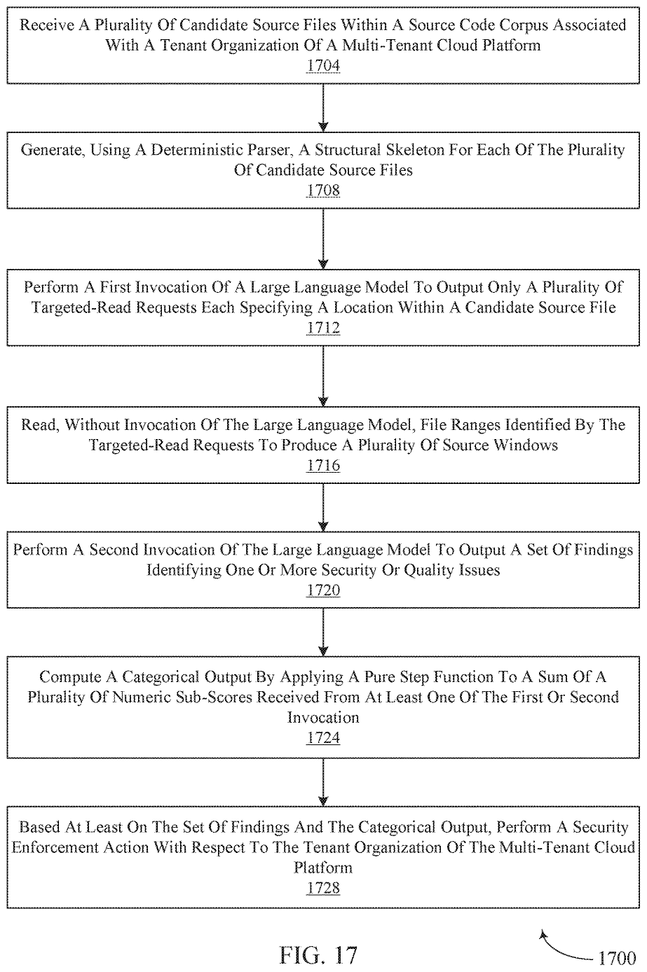

FIG. 17 is a flow diagram of a process 1700 for bounded agentic source code analysis using structural skeletons and large language model invocations, according to the present teachings. Although the process steps are described with reference to the systems and processes of FIGS. 1-16, persons skilled in the art will understand that any system adapted to implement the process steps, in any order, falls within the scope of the present invention.

At step 1704, the process 1700 can include receiving a plurality of candidate source files within a source code corpus associated with a tenant organization of a multi-tenant cloud platform. For example, the risk assessment module 224 of the cloud infrastructure security service 132 can receive, from the multi-tenant cloud platform 124 via the one or more cloud platform APIs 128, a plurality of candidate source files within a source code corpus associated with a connected tenant organization. In some examples, the candidate source files may be received responsive to submission of a pull request, upon a scheduled security assessment, or upon detection of a configuration change that may implicate source code components associated with the tenant organization.

Receiving the plurality of candidate source files can include selecting, from a registry of framework descriptors, a descriptor whose filename predicate matches each candidate source file, each descriptor comprising at least an identity, a filename predicate, and/or a prompt builder. In some examples, responsive to two or more descriptors matching a single candidate source file, a source-content predicate of each matching descriptor is evaluated against the source of the candidate source file to select exactly one descriptor.

At step 1708, the process 1700 can include generating, using a deterministic parser, a structural skeleton for each of the plurality of candidate source files. For example, the risk assessment module 224 of the cloud infrastructure security service 132 can invoke a deterministic parser, prior to any invocation of a large language model, to generate a structural skeleton for each candidate source file received at step 1704. In some examples, the structural skeletons may be stored in the system disk 1624 of the system computing device 104 as source code and structural skeletons 1644 for use in subsequent analysis steps.

The pre-computation of structural skeletons by a deterministic parser prior to any LLM invocation can provide a specific computational improvement over approaches that rely on the language model to extract structural information from raw source code. Because the deterministic parser produces an identical skeleton for a given source file on each invocation, the skeleton may be cached and reused across multiple analysis runs without re-parsing unchanged files, reducing repeated computational overhead. The structural skeleton is a compact summary of the source file's member-level organization, omitting member bodies, which allows the language model to understand the organizational structure of large code bases without being presented with implementation details that are irrelevant to the targeted-read selection task. This structural pre-processing step improves the overall computational efficiency of the analysis pipeline by ensuring that the LLM invocation at step 1712 is presented only with the information necessary for that stage of the pipeline.

In some examples, each structural skeleton comprises at least class identifiers, member signatures, annotations, and line ranges, and omits member bodies of the corresponding candidate source file.

At step 1712, the process 1700 can include performing a first invocation of a large language model to output only a plurality of targeted-read requests each specifying a location within a candidate source file. The first invocation can include the structural skeletons and can have a context bounded by a function of a size of the structural skeletons and a size of targeted source-content portions retrieved from the plurality of candidate source files. For example, the risk assessment module 224 of the cloud infrastructure security service 132 can invoke one or more LLM agents 228 with the structural skeletons generated at step 1708 and the scanner hints produced by the deterministic static analyzer, such that the first invocation may function as a triage pass that identifies which portions of the candidate source files require closer examination without emitting findings. The first invocation further may include a set of scanner hints produced by executing a deterministic static analyzer over the plurality of candidate source files, each scanner hint identifying a file, a line or range, and a rule key.

In some examples, the first invocation is further to emit no findings with respect to the one or more security or quality issues within the plurality of candidate source files. In some examples, a system prompt associated with the first invocation can require that the large language model does not emit a negative result for any candidate source file unless the large language model has previously received, through the skeleton-retrieval tool, the structural skeleton of that candidate source file.

At step 1716, the process 1700 can include reading, without invocation of the large language model, file ranges identified by the targeted-read requests to produce a plurality of source windows. For example, the risk assessment module 224 of the cloud infrastructure security service 132 can read, using a line-range file-read tool and without invoking any of the one or more LLM agents 228, the file ranges identified by the targeted-read requests emitted at step 1712, thereby producing a plurality of source windows comprising the actual source content at the requested offsets and limits. As used herein, the term “source window” may refer to a bounded excerpt of source content retrieved from a candidate source file at a specified offset and limit, as identified by a targeted-read request emitted by the first large language model invocation.

At step 1720, the process 1700 can include performing a second invocation of the large language model to output a set of findings identifying one or more security or quality issues. The second invocation can include the structural skeletons and the plurality of source windows. A context of the second invocation can be bounded by the sum of the size of the structural skeletons and the size of the source windows and is independent of a number of targeted-read requests. For example, the risk assessment module 224 of the cloud infrastructure security service 132 can perform a second invocation of one or more LLM agents 228 whose input consists of the structural skeletons generated at step 1708, the source windows produced at step 1716, and the scanner hints produced by the deterministic static analyzer, such that the second invocation may emit a set of findings identifying one or more security or quality issues within the candidate source files.

The two-stage bounded-context pipeline described herein can address the specific technical problem of unbounded token consumption in LLM-based source code analysis. The first invocation at step 1712 is provided with structural skeletons that omit member bodies, which reduces the token representation of the repository by a factor proportional to the ratio of total source length to member-signature length, which may be an order-of-magnitude reduction for large code bases. The first invocation outputs only targeted-read requests specifying file locations, without generating any findings, which further limits its output token count. The second invocation at step 1720 receives only the structural skeletons and the source windows selected by the targeted reads, such that its context is bounded by the sum of the skeleton size and the source window size and is independent of the total number of targeted-read requests and independent of total repository size. As a result, adding additional source files to the repository beyond those selected by the targeted reads does not increase the context of the second invocation. This structural property allows the techniques described herein to analyze repositories that would exceed the context limit of the language model under prior approaches, without requiring a larger context model or splitting analysis across multiple independent invocations that each lack full repository context. This represents a specific improvement to how the LLM inference component of the system operates, and not merely the application of a conventional LLM technique to a new field.

In some examples, conversation history from the first invocation is not carried into the second invocation.

At step 1724, the process 1700 can include computing a categorical output by applying a pure step function to a sum of a plurality of numeric sub-scores received from at least one of the first or second invocation. For example, the risk assessment module 224 of the cloud infrastructure security service 132 can apply a pure step function to the sum of the numeric sub-scores received from one or more of the LLM agents 228 at step 1712 or step 1720, thereby computing a categorical output that is bit-identical across applications of the pure step function with identical numeric input. In some examples, the categorical output may be consumed by a rule-based policy engine to determine whether a security enforcement action is warranted with respect to the tenant organization.

The numeric sub-scores at step 1724 can be produced by the LLM agents 228 as a structured output record comprising named dimension fields each assigned an integer value within a defined closed interval such as 0 to 10, including for example a complexity dimension, securityrisk dimension, maintainability dimension, and test-coverage dimension. The pure step function is implemented as a deterministic algorithm on the processor 1604: summing the integer values of all dimension sub-scores; and applying a lookup table or conditional branching structure stored in the system memory 1620 mapping non-overlapping integer ranges to categorical labels from a closed ordered set such as PASS, WARN, and FAIL. The mapping is statically defined and does not vary across invocations such that the categorical output is bit-identical across applications with identical numeric input. For example, a sum in the range 0 to 15 may map to PASS, a sum of 16 to 25 may map to WARN, and a sum above 25 may map to FAIL.

In some examples, the plurality of numeric sub-scores comprises, for each identified member of a candidate source file, a set of dimension-specific sub-scores each bounded to a fixed integer interval. In some examples, a subset of scoring dimensions whose output is deterministically computable by a static rule engine from the source of the identified member is excluded from the first invocation or the second invocation.

In some examples, the categorical output is bit-identical across applications of the pure step function with identical numeric input.

The use of a pure step function to compute the categorical output from numeric sub-scores can provide a specific technical improvement in the context of security enforcement. Security enforcement decisions must be reproducible and auditable: a system that produces a different enforcement decision (block, warn, pass) on repeated application to the same source code would be unreliable for governance purposes. By computing the categorical output through a deterministic step function that is bit-identical across applications with identical numeric input, the techniques described herein ensure that the enforcement decision is reproducible from the recorded sub-scores alone, independent of any nondeterminism in the language model. This property structurally limits the impact of any language model nondeterminism to the sub-score values themselves, preventing nondeterminism from propagating into the final enforcement action. This is a specific technical improvement to the reliability and auditability of the security enforcement pipeline.

By way of example, the second LLM invocation may emit, for an identified member of a candidate source file, a structured output record comprising the dimension-specific numeric sub-scores {complexity: 2, securityRisk: 8, maintainability: 3, testCoverage: 2}, each bounded to the closed integer interval [0, 10]. The pure step function can sum the sub-scores to produce 2+8+3+2=15 and can apply the static lookup table to map the sum to the categorical label PASS according to the mapping [0, 15]→PASS, [16, 25]→WARN, [26, ∞)→FAIL.

Under the same lookup table, sub-scores of {complexity: 5, securityRisk: 8, maintainability: 5, testCoverage: 4} may produce a sum of 22 and a categorical label of WARN, and sub-scores of {complexity: 8, securityRisk: 9, maintainability: 7, testCoverage: 6} may produce a sum of 30 and a categorical label of FAIL.

Because the pure step function can be deterministic and free of side effects, repeated applications to the same numeric sub-scores can produce a bit-identical categorical label, thereby supporting reproducibility and auditability of the security enforcement decision derived from the categorical label.

At step 1728, the process 1700 can include, based at least on the set of findings and the categorical output, performing a security enforcement action with respect to the tenant organization of the multi-tenant cloud platform. The security enforcement action can be to block a deployment to the tenant organization of the multi-tenant cloud platform, flag a pull request associated with the source code corpus, generate a deviation finding identifying a security or quality issue within the plurality of candidate source files, transmit a structured alert to a security service API associated with the tenant organization, or a combination thereof. For example, the risk assessment module 224 of the cloud infrastructure security service 132 can perform the security enforcement action by transmitting one or more signals to the at least one client computing device 116 via the one or more security service APIs 136, or by interacting with the multi-tenant cloud platform 124 via the one or more cloud platform APIs 128, based on the set of findings produced at step 1720 and the categorical output computed at step 1724.

In some examples, the first invocation and the second invocation each receive a language-specific scanner-contradiction catalogue enumerating known false-positive patterns of a static analyzer in natural language, and wherein the set of findings output by the second invocation omits scanner hints contradicted by the plurality of source windows under the scanner-contradiction catalogue.

In some examples, at least one of the first invocation or the second invocation comprises invoking the large language model as an agent with a tool surface having a closed read-only set comprising at least a skeleton-retrieval tool returning a pre-computed structural skeleton, a line-range file-read tool accepting a file identifier, a starting line offset, and a line limit, a directory-listing tool, a filename-pattern tool, a content-pattern tool, or a combination thereof.

In some examples, the process 1700 can include serializing the set of findings and the categorical output to a token-optimized textual notation having a character count smaller than a JavaScript Object Notation serialization of the set of findings and the categorical output. In such examples, the process 1700 can include invoking a second large language model stage with the serialized token-optimized textual notation as input. The second large language model stage can operate in a model tier of higher per-token cost than a model tier used for the first invocation and the second invocation.

In some examples, the process 1700 can include caching each computed structural skeleton, and upon a subsequent reference to a candidate source file already processed during a same analysis run, serving the cached structural skeleton without re-invoking the deterministic parser.

The techniques described herein provide specific improvements to how computing systems perform automated security and compliance analysis in multi-tenant cloud environments. These improvements include: structurally bounding the context of large language model invocations to allow effective analysis of large source code repositories that would exceed conventional context limits; improving the reproducibility and auditability of security enforcement decisions by computing categorical outputs through deterministic step functions rather than language model verdicts; improving the security of agentic AI deployments by architecturally constraining the agent's available tool surface to a statically defined closed set of read-only functions; reducing the computational cost of multi-tenant data field classification by applying deterministic gating to select only the subset of fields requiring deep-value inference; improving the efficiency of cloud platform API interaction by adaptively learning and persisting successful batch sizes; and improving the reliability of LLM-based policy compilation by requiring structured-output schema conformance before persisting compiled rules. Each of these improvements addresses a specific technical problem that arises in computing systems that apply language model inference in multi-tenant cloud security contexts, and each improvement is implemented by specific structural components and algorithms described herein.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A process comprising:
receiving a plurality of candidate source files within a source code corpus associated with a tenant organization of a multi-tenant cloud platform;
generating, using a deterministic parser, a structural skeleton for each of the plurality of candidate source files;
performing a first invocation of a large language model to output a plurality of targeted-read requests each specifying a location within a candidate source file, the first invocation including the structural skeletons and having a context bounded by a function of a size of the structural skeletons and a size of targeted source-content portions retrieved from the plurality of candidate source files;
reading, without invocation of the large language model, file ranges identified by the targeted-read requests to produce a plurality of source windows;
performing a second invocation of the large language model to output a set of findings identifying one or more security or quality issues, the second invocation including the structural skeletons and the plurality of source windows, wherein a context of the second invocation is bounded by the sum of the size of the structural skeletons and the size of the source windows and is independent of a number of targeted-read requests;
computing a categorical output by applying a pure step function to a sum of a plurality of numeric sub-scores received from at least one of the first or second invocation; and
based at least on the set of findings and the categorical output, performing a security enforcement action with respect to the tenant organization of the multi-tenant cloud platform to block a deployment to the tenant organization of the multi-tenant cloud platform, flag a pull request associated with the source code corpus, generate a deviation finding identifying a security or quality issue within the plurality of candidate source files, transmit a structured alert to a security service API associated with the tenant organization, or a combination thereof.

2. The process of claim 1, wherein the first invocation is further to emit no findings with respect to the one or more security or quality issues within the plurality of candidate source files.

3. The process of claim 1, wherein conversation history from the first invocation is not carried into the second invocation.

4. The process of claim 1, wherein the categorical output is bit-identical across applications of the pure step function with identical numeric input.

5. The process of claim 1, wherein each structural skeleton comprises at least class identifiers, member signatures, annotations, and line ranges, and omits member bodies of the corresponding candidate source file.

6. The process of claim 1, wherein the first invocation and the second invocation each receive a language-specific scanner-contradiction catalogue enumerating known false-positive patterns of a static analyzer in natural language, and wherein the set of findings output by the second invocation omits scanner hints contradicted by the plurality of source windows under the scanner-contradiction catalogue.

7. The process of claim 1, wherein the first invocation further includes a set of scanner hints produced by executing a deterministic static analyzer over the plurality of candidate source files, each scanner hint identifying a file, a line or range, and a rule key.

8. The process of claim 1, wherein at least one of the first invocation or the second invocation comprises invoking the large language model as an agent with a tool surface having a closed read-only set comprising at least a skeleton-retrieval tool returning a pre-computed structural skeleton, a line-range file-read tool accepting a file identifier, a starting line offset, and a line limit, a directory-listing tool, a filename-pattern tool, a content-pattern tool, or a combination thereof.

9. The process of claim 8, wherein a system prompt associated with the first invocation requires that the large language model does not emit a negative result for any candidate source file unless the large language model has previously received, through the skeleton-retrieval tool, the structural skeleton of that candidate source file.

10. The process of claim 1, wherein the plurality of numeric sub-scores comprises, for each identified member of a candidate source file, a set of dimension-specific sub-scores each bounded to a fixed integer interval, and wherein a subset of scoring dimensions whose output is deterministically computable by a static rule engine from the source of the identified member is excluded from the first invocation or the second invocation.

11. The process of claim 1, further comprising:
serializing the set of findings and the categorical output to a token-optimized textual notation having a character count smaller than a JavaScript Object Notation serialization of the set of findings and the categorical output; and
invoking a second large language model stage with the serialized token-optimized textual notation as input, the second large language model stage operating in a model tier of higher per-token cost than a model tier used for the first invocation and the second invocation.

12. The process of claim 1, further comprising:
caching each computed structural skeleton, and upon a subsequent reference to a candidate source file already processed during a same analysis run, serving the cached structural skeleton without re-invoking the deterministic parser.

13. The process of claim 1, wherein receiving the plurality of candidate source files comprises:
selecting, from a registry of framework descriptors, a descriptor whose filename predicate matches each candidate source file, each descriptor comprising at least an identity, a filename predicate, and/or a prompt builder, and wherein, responsive to two or more descriptors matching a single candidate source file, a source-content predicate of each matching descriptor is evaluated against the source of the candidate source file to select exactly one descriptor.

14. A computing system comprising:
a processor; and
a non-transitory computer readable medium storing instructions executable to:
receive a plurality of candidate source files within a source code corpus associated with a tenant organization of a multi-tenant cloud platform;
generate a structural skeleton for each of the plurality of candidate source files;
perform a first invocation of a large language model to output a plurality of targeted-read requests each specifying a location within a candidate source file, the first invocation having a context bounded by a function of a size of the structural skeletons and a size of targeted source-content portions retrieved from the plurality of candidate source files;
read file ranges identified by the targeted-read requests to produce a plurality of source windows;
perform a second invocation of the large language model to output a set of findings identifying one or more security or quality issues, wherein a context of the second invocation is bounded by the sum of the size of the structural skeletons and the size of the source windows and is independent of a number of targeted-read requests;
compute a categorical output by applying a pure step function to a sum of a plurality of numeric sub-scores received from at least one of the first or second invocation; and
perform a security enforcement action with respect to the tenant organization of the multi-tenant cloud platform based at least on the set of findings and the categorical output.

15. The computing system of claim 14, wherein the first invocation is further to emit no findings with respect to the one or more security or quality issues within the plurality of candidate source files.

16. The computing system of claim 14, wherein conversation history from the first invocation is not carried into the second invocation.

17. The computing system of claim 14, wherein the first invocation further includes a set of scanner hints produced by executing a deterministic static analyzer over the plurality of candidate source files, each scanner hint identifying a file, a line or range, and a rule key, and wherein the first invocation and the second invocation each receive a language-specific scanner-contradiction catalogue enumerating known false-positive patterns of the deterministic static analyzer in natural language, and wherein the set of findings output by the second invocation omits scanner hints contradicted by the plurality of source windows under the scanner-contradiction catalogue.

18. The computing system of claim 14, wherein at least one of the first invocation or the second invocation comprises invoking the large language model as an agent with a tool surface having a closed read-only set comprising at least a skeleton-retrieval tool returning a pre-computed structural skeleton, a line-range file-read tool accepting a file identifier, a starting line offset, and a line limit, a directory-listing tool, a filename-pattern tool, a content-pattern tool, or a combination thereof.

19. The computing system of claim 14, wherein the instructions are further executable to:
serialize the set of findings and the categorical output to a token-optimized textual notation having a character count smaller than a JavaScript Object Notation serialization of the set of findings and the categorical output; and
invoke a second large language model stage with the serialized token-optimized textual notation as input, the second large language model stage operating in a model tier of higher per-token cost than a model tier used for the first invocation and the second invocation.

20. A non-transitory computer readable medium storing instructions executable to:
receive a plurality of candidate source files within a source code corpus associated with a tenant organization of a multi-tenant cloud platform;
generate a structural skeleton for each of the plurality of candidate source files;
perform a first invocation of a large language model to output a plurality of targeted-read requests each specifying a location within a candidate source file, the first invocation having a context bounded by a function of a size of the structural skeletons and a size of targeted source-content portions retrieved from the plurality of candidate source files;
read file ranges identified by the targeted-read requests to produce a plurality of source windows;
perform a second invocation of the large language model to output a set of findings identifying one or more security or quality issues, wherein a context of the second invocation is bounded by the sum of the size of the structural skeletons and the size of the source windows and is independent of a number of targeted-read requests;
compute a categorical output by applying a pure step function to a sum of a plurality of numeric sub-scores received from at least one of the first or second invocation; and
perform a security enforcement action with respect to the tenant organization of the multi-tenant cloud platform based at least on the set of findings and the categorical output.
